(19) United States
(12) Patent Application Publication
(10) Pub. No.: US 2023/0156525 A1
(43) Pub. Date: May 18, 2023

(54) TRANSMISSION POWER ADJUSTMENT FOR STR OPERATION

(71) Applicant: LG ELECTRONICS INC., Seoul (KR)

(72) Inventors: Jeongki Kim, Seoul (KR); Jinsoo Choi, Seoul (KR)

(21) Appl. No.: 17/917,495

(22) PCT Filed: Apr. 12, 2021
(86) PCT No.: PCT/KR2021/004571

§ 371 Date: Oct. 6, 2022

(30) Foreign Application Priority Data
Apr. 10, 2020 (KR) 10-2020-0044177
Jun. 22, 2020 (KR) 10-2020-0075872
Jul. 3, 2020 (KR) 10-2020-0082234
Jul. 7, 2020 (KR) 10-2020-0083582
Jul. 8, 2020 (KR) 10-2020-0084244
Jul. 14, 2020 (KR) 10-2020-0086941
Oct. 26, 2020 (KR) 10-2020-0139484

(51) Int. Cl. H04W 28/20; H04W 52/14; H04W 76/15

(52) U.S. Cl. CPC H04W 28/20; H04W 52/14; H04W 76/15; H04W 84/12

(57) ABSTRACT

In a wireless local area network system, a non-AP multi-link device (MLD) can transmit transmission power information enabling links in an NSTR relationship to operate as STR and information about a PPDU bandwidth, and operate as STR in the links in the NSTR relationship under a specific condition, on the basis thereof.

### BACKGROUND

### Technical Field

The present specification relates to a method for STR operation between non-STR links in a wireless local area network (WLAN) system.

### Related Art

A wireless local area network (WLAN) has been enhanced in various ways. For example, the Institute of Electrical and Electronics Engineers (IEEE) 802.11ax standard has proposed an enhanced communication environment by using orthogonal frequency division multiple access (OFDMA) and downlink multi-user multiple input multiple output (DL MU MIMO) schemes.

The present specification proposes a technical feature that can be utilized in a new communication standard. For example, the new communication standard may be an extreme high throughput (EHT) standard which is currently being discussed. The EHT standard may use an increased bandwidth, an enhanced PHY layer protocol data unit (PPDU) structure, an enhanced sequence, a hybrid automatic repeat request (HARQ) scheme, or the like, which is newly proposed. The EHT standard may be called the IEEE 802.11be standard.

### SUMMARY

A method performed by a non-AP (access point) STA (station) multi-link device (MLD) in a wireless local area network (WLAN) system according to various embodiments may include relevant technical feature for NSTR links to perform an STR operation A method, which is related to a wireless LAN system and is performed by a non-access point (non-AP) station (STA) multi-link device (MLD), may comprise: wherein the non-AP STA MLD includes first and second STAs, the first STA operates on a first link, the second STA operates on a second link, and the first and second links are in non-simultaneous transmit and receive (NSTR) relationship, generating, by the non-AP STA MLD, simultaneous transmit and receive (STR) information for the first and second links to operate as simultaneous transmit and receive (STR), wherein the STR information includes information related to transmission power and a bandwidth of a physical protocol data unit (PPDU); and transmitting, by the non-AP STA MLD, a PPDU including the STR information to an AP MLD.

### Technical Effects

According to an example of the present specification, even in a non-STR link, information enabling operation as an STR under a specific condition may be transmitted. Accordingly, there may occur a case in which the STR operation is supported in the non-STR link, so that efficient multi-link-based communication may be possible.

### BRIEF DESCRIPTION OF THE DRAWINGS

FIG. 1 shows an example of a transmitting apparatus and/or receiving apparatus of the present specification.

FIG. 2 is a conceptual view illustrating the structure of a wireless local area network (WLAN).

FIG. 3 illustrates a general link setup process.

FIG. 4 illustrates a layout of resource units (RUs) used in a band of 80 MHz.

FIG. 5 illustrates an operation based on UL-MU.

FIG. 6 illustrates an example of a trigger frame.

FIG. 7 illustrates an example of a common information field of a trigger frame.

FIG. 8 illustrates an example of a subfield included in a per user information field.

FIG. 9 illustrates an example of a PPDU used in the present specification.

FIG. 10 illustrates an example of a modified transmission device and/or receiving device of the present specification.

FIG. 11 shows an example of channel bonding.

FIG. 12 is a diagram illustrating an embodiment of a device supporting multi-link.

FIG. 13 is a diagram illustrating an embodiment of multi-link aggregation.

FIG. 14 is a diagram illustrating an embodiment of STR and non-STR operations.

FIG. 15 and FIG. 16 are diagrams illustrating an embodiment of an STR operation.

FIG. 17 is a diagram showing an example of information for STR operation.

FIG. 18 is a diagram illustrating an embodiment of a multi-link setup operation.

FIG. 19 is a diagram showing an embodiment of an enhanced STR link pair.

FIG. 20 shows an example of transmitting a UL SU frame in one link corresponding to non-STR when a DL frame is received in another link.

FIG. 21 to FIG. 26 are diagrams illustrating an embodiment of an STR operation in a non-STR link.

FIG. 27 shows an example in which an AP in the diagram below transmits capability information to a terminal.

FIG. 28 is a diagram illustrating an embodiment of a non-AP STA MLD operation method.

FIG. 29 is a diagram illustrating an embodiment of an AP MLD operation method.

### DESCRIPTION OF EXEMPLARY EMBODIMENTS

In the present specification, “A or B” may mean “only A”, “only B” or “both A and B”. In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”.

In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (EHT-signal)”, it may mean that “EHT-signal” is proposed as an example of the “control information”. In other words, the “control information” of the present specification is not limited to “EHT-signal”, and “EHT-signal” may be proposed as an example of the “control information”. In addition, when indicated as “control information (i.e., EHT-signal)”, it may also mean that “EHT-signal” is proposed as an example of the “control information”.

Technical features described individually in one figure in the present specification may be individually implemented, or may be simultaneously implemented.

The following example of the present specification may be applied to various wireless communication systems. For example, the following example of the present specification may be applied to a wireless local area network (WLAN) system. For example, the present specification may be applied to the IEEE 802.11a/g/n/ac standard or the IEEE 802.11ax standard. In addition, the present specification may also be applied to the newly proposed EHT standard or IEEE 802.11be standard. In addition, the example of the present specification may also be applied to a new WLAN standard enhanced from the EHT standard or the IEEE 802.11 be standard. In addition, the example of the present specification may be applied to a mobile communication system. For example, it may be applied to a mobile communication system based on long term evolution (LTE) depending on a 3rd generation partnership project (3GPP) standard and based on evolution of the LTE. In addition, the example of the present specification may be applied to a communication system of a 5G NR standard based on the 3GPP standard.

Hereinafter, in order to describe a technical feature of the present specification, a technical feature applicable to the present specification will be described.

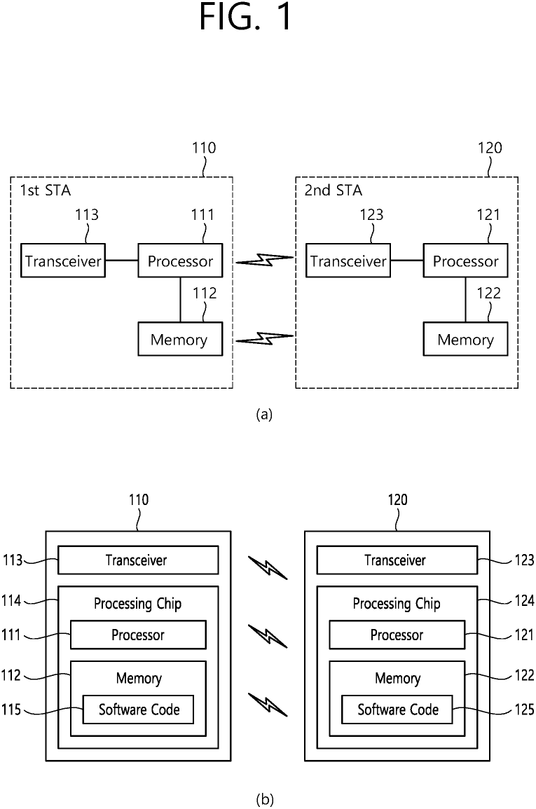

FIG. 1 shows an example of a transmitting apparatus and/or receiving apparatus of the present specification.

In the example of FIG. 1, various technical features described below may be performed. FIG. 1 relates to at least one station (STA). For example, STAs 110 and 120 of the present specification may also be called in various terms such as a mobile terminal, a wireless device, a wireless transmit/receive unit (WTRU), a user equipment (UE), a mobile station (MS), a mobile subscriber unit, or simply a user. The STAs 110 and 120 of the present specification may also be called in various terms such as a network, a base station, a node-B, an access point (AP), a repeater, a router, a relay, or the like. The STAs 110 and 120 of the present specification may also be referred to as various names such as a receiving apparatus, a transmitting apparatus, a receiving STA, a transmitting STA, a receiving device, a transmitting device, or the like.

For example, the STAs 110 and 120 may serve as an AP or a non-AP. That is, the STAs 110 and 120 of the present specification may serve as the AP and/or the non-AP. In the present specification, the AP may be indicated as an AP STA.

The STAs 110 and 120 of the present specification may support various communication standards together in addition to the IEEE 802.11 standard. For example, a communication standard (e.g., LTE, LTE-A, 5G NR standard) or the like based on the 3GPP standard may be supported. In addition, the STA of the present specification may be implemented as various devices such as a mobile phone, a vehicle, a personal computer, or the like. In addition, the STA of the present specification may support communication for various communication services such as voice calls, video calls, data communication, and self-driving (autonomous-driving), or the like.

The STAs 110 and 120 of the present specification may include a medium access control (MAC) conforming to the IEEE 802.11 standard and a physical layer interface for a radio medium.

The STAs 110 and 120 will be described below with reference to a sub-figure(a) of FIG. 1.

The first STA 110 may include a processor 111, a memory 112, and a transceiver 113. The illustrated process, memory, and transceiver may be implemented individually as separate chips, or at least two blocks/functions may be implemented through a single chip.

The transceiver 113 of the first STA performs a signal transmission/reception operation. Specifically, an IEEE 802.11 packet (e.g., IEEE 802. 11a/b/g/n/ac/ax/be, etc.) may be transmitted/received.

For example, the first STA 110 may perform an operation intended by an AP. For example, the processor 111 of the AP may receive a signal through the transceiver 113, process a reception (RX) signal, generate a transmission (TX) signal, and provide control for signal transmission. The memory 112 of the AP may store a signal (e.g., RX signal) received through the transceiver 113, and may store a signal (e.g., TX signal) to be transmitted through the transceiver.

For example, the second STA 120 may perform an operation intended by a non-AP STA. For example, a transceiver 123 of a non-AP performs a signal transmission/reception operation. Specifically, an IEEE 802.11 packet (e.g., IEEE 802.11a/b/g/n/ac/ax/be packet, etc.) may be transmitted/received.

For example, a processor 121 of the non-AP STA may receive a signal through the transceiver 123, process an RX signal, generate a TX signal, and provide control for signal transmission. A memory 122 of the non-AP STA may store a signal (e.g., RX signal) received through the transceiver 123, and may store a signal (e.g., TX signal) to be transmitted through the transceiver.

For example, an operation of a device indicated as an AP in the specification described below may be performed in the first STA 110 or the second STA 120. For example, if the first STA 110 is the AP, the operation of the device indicated as the AP may be controlled by the processor 111 of the first STA 110, and a related signal may be transmitted or received through the transceiver 113 controlled by the processor 111 of the first STA 110. In addition, control information related to the operation of the AP or a TX/RX signal of the AP may be stored in the memory 112 of the first STA 110. In addition, if the second STA 120 is the AP, the operation of the device indicated as the AP may be controlled by the processor 121 of the second STA 120, and a related signal may be transmitted or received through the transceiver 123 controlled by the processor 121 of the second STA 120. In addition, control information related to the operation of the AP or a TX/RX signal of the AP may be stored in the memory 122 of the second STA 120.

For example, in the specification described below, an operation of a device indicated as a non-AP (or user-STA) may be performed in the first STA 110 or the second STA 120. For example, if the second STA 120 is the non-AP, the operation of the device indicated as the non-AP may be controlled by the processor 121 of the second STA 120, and a related signal may be transmitted or received through the transceiver 123 controlled by the processor 121 of the second STA 120. In addition, control information related to the operation of the non-AP or a TX/RX signal of the non-AP may be stored in the memory 122 of the second STA 120. For example, if the first STA 110 is the non-AP, the operation of the device indicated as the non-AP may be controlled by the processor 111 of the first STA 110, and a related signal may be transmitted or received through the transceiver 113 controlled by the processor 111 of the first STA 110. In addition, control information related to the operation of the non-AP or a TX/RX signal of the non-AP may be stored in the memory 112 of the first STA 110.

In the specification described below, a device called a (transmitting/receiving) STA, a first STA, a second STA, an STA1, an STA2, an AP, a first AP, a second AP, an AP1, an AP2, a (transmitting/receiving) terminal, a (transmitting/receiving) device, a (transmitting/receiving) apparatus, a network, or the like may imply the STAs 110 and 120 of FIG. 1. For example, a device indicated as, without a specific reference numeral, the (transmitting/receiving) STA, the first STA, the second STA, the STA1, the STA2, the AP, the first AP, the second AP, the AP1, the AP2, the (transmitting/receiving) terminal, the (transmitting/receiving) device, the (transmitting/receiving) apparatus, the network, or the like may imply the STAs 110 and 120 of FIG. 1. For example, in the following example, an operation in which various STAs transmit/receive a signal (e.g., a PPDU) may be performed in the transceivers 113 and 123 of FIG. 1. In addition, in the following example, an operation in which various STAs generate a TX/RX signal or perform data processing and computation in advance for the TX/RX signal may be performed in the processors 111 and 121 of FIG. 1. For example, an example of an operation for generating the TX/RX signal or performing the data processing and computation in advance may include: 1) an operation of determining/obtaining/configuring/computing/decoding/encoding bit information of a sub-field (SIG, STF, LTF, Data) included in a PPDU; 2) an operation of determining/configuring/obtaining a time resource or frequency resource (e.g., a subcarrier resource) or the like used for the sub-field (SIG, STF, LTF, Data) included the PPDU; 3) an operation of determining/configuring/obtaining a specific sequence (e.g., a pilot sequence, an STF/LTF sequence, an extra sequence applied to SIG) or the like used for the sub-field (SIG, STF, LTF, Data) field included in the PPDU; 4) a power control operation and/or power saving operation applied for the STA; and 5) an operation related to determining/obtaining/configuring/decoding/encoding or the like of an ACK signal. In addition, in the following example, a variety of information used by various STAs for determining/obtaining/configuring/computing/decoding/decoding a TX/RX signal (e.g., information related to a field/subfield/control field/parameter/power or the like) may be stored in the memories 112 and 122 of FIG. 1.

The aforementioned device/STA of the sub-figure (a) of FIG. 1 may be modified as shown in the sub-figure (b) of FIG. 1. Hereinafter, the STAs 110 and 120 of the present specification will be described based on the sub-figure (b) of FIG. 1.

For example, the transceivers 113 and 123 illustrated in the sub-figure (b) of FIG. 1 may perform the same function as the aforementioned transceiver illustrated in the sub-figure (a) of FIG. 1. For example, processing chips 114 and 124 illustrated in the sub-figure (b) of FIG. 1 may include the processors 111 and 121 and the memories 112 and 122. The processors 111 and 121 and memories 112 and 122 illustrated in the sub-figure (b) of FIG. 1 may perform the same function as the aforementioned processors 111 and 121 and memories 112 and 122 illustrated in the sub-figure (a) of FIG. 1.

A mobile terminal, a wireless device, a wireless transmit/receive unit (WTRU), a user equipment (UE), a mobile station (MS), a mobile subscriber unit, a user, a user STA, a network, a base station, a Node-B, an access point (AP), a repeater, a router, a relay, a receiving unit, a transmitting unit, a receiving STA, a transmitting STA, a receiving device, a transmitting device, a receiving apparatus, and/or a transmitting apparatus, which are described below, may imply the STAs 110 and 120 illustrated in the sub-figure (a)/(b) of FIG. 1, or may imply the processing chips 114 and 124 illustrated in the sub-figure (b) of FIG. 1. That is, a technical feature of the present specification may be performed in the STAs 110 and 120 illustrated in the sub-figure (a)/(b) of FIG. 1, or may be performed only in the processing chips 114 and 124 illustrated in the sub-figure (b) of FIG. 1. For example, a technical feature in which the transmitting STA transmits a control signal may be understood as a technical feature in which a control signal generated in the processors 111 and 121 illustrated in the sub-figure (a)/(b) of FIG. 1 is transmitted through the transceivers 113 and 123 illustrated in the sub-figure (a)/(b) of FIG. 1. Alternatively, the technical feature in which the transmitting STA transmits the control signal may be understood as a technical feature in which the control signal to be transferred to the transceivers 113 and 123 is generated in the processing chips 114 and 124 illustrated in the sub-figure (b) of FIG. 1.

For example, a technical feature in which the receiving STA receives the control signal may be understood as a technical feature in which the control signal is received by means of the transceivers 113 and 123 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (a) of FIG. 1 is obtained by the processors 111 and 121 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (b) of FIG. 1 is obtained by the processing chips 114 and 124 illustrated in the sub-figure (b) of FIG. 1.

Referring to the sub-figure (b) of FIG. 1, software codes 115 and 125 may be included in the memories 112 and 122. The software codes 115 and 126 may include instructions for controlling an operation of the processors 111 and 121. The software codes 115 and 125 may be included as various programming languages.

The processors 111 and 121 or processing chips 114 and 124 of FIG. 1 may include an application-specific integrated circuit (ASIC), other chipsets, a logic circuit and/or a data processing device. The processor may be an application processor (AP). For example, the processors 111 and 121 or processing chips 114 and 124 of FIG. 1 may include at least one of a digital signal processor (DSP), a central processing unit (CPU), a graphics processing unit (GPU), and a modulator and demodulator (modem). For example, the processors 111 and 121 or processing chips 114 and 124 of FIG. 1 may be SNAPDRAGONTM series of processors made by Qualcomm®, EXYNOSTM series of processors made by Samsung®, A series of processors made by Apple®, HELIOTM series of processors made by MediaTek®, ATOMTM series of processors made by Intel® or processors enhanced from these processors.

In the present specification, an uplink may imply a link for communication from a non-AP STA to an SP STA, and an uplink PPDU/packet/signal or the like may be transmitted through the uplink. In addition, in the present specification, a downlink may imply a link for communication from the AP STA to the non-AP STA, and a downlink PPDU/packet/signal or the like may be transmitted through the downlink.

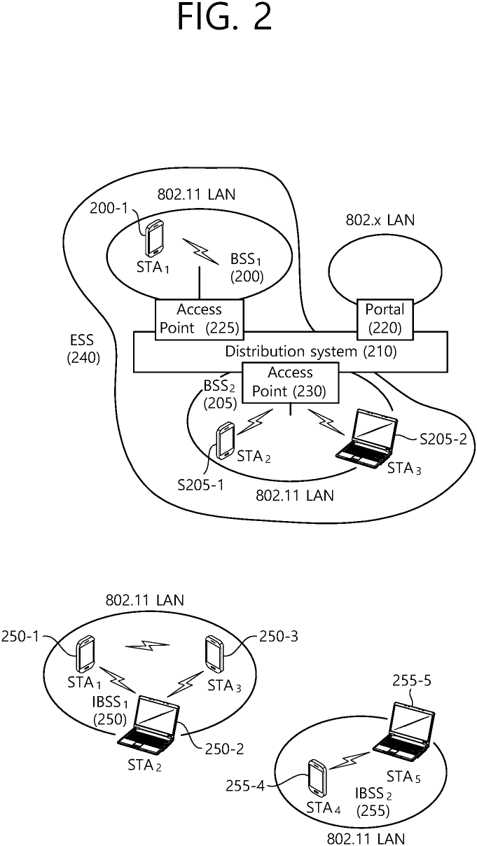

FIG. 2 is a conceptual view illustrating the structure of a wireless local area network (WLAN).

An upper part of FIG. 2 illustrates the structure of an infrastructure basic service set (BSS) of institute of electrical and electronic engineers (IEEE) 802.11.

Referring the upper part of FIG. 2, the wireless LAN system may include one or more infrastructure BSSs 200 and 205 (hereinafter, referred to as BSS). The BSSs 200 and 205 as a set of an AP and a STA such as an access point (AP) 225 and a station (STA1) 200-1 which are successfully synchronized to communicate with each other are not concepts indicating a specific region. The BSS 205 may include one or more STAs 205-1 and 205-2 which may be joined to one AP 230.

The BSS may include at least one STA, APs providing a distribution service, and a distribution system (DS) 210 connecting multiple APs.

The distribution system 210 may implement an extended service set (ESS) 240 extended by connecting the multiple BSSs 200 and 205. The ESS 240 may be used as a term indicating one network configured by connecting one or more APs 225 or 230 through the distribution system 210. The AP included in one ESS 240 may have the same service set identification (SSID).

A portal 220 may serve as a bridge which connects the wireless LAN network (IEEE 802.11) and another network (e.g., 802.X).

In the BSS illustrated in the upper part of FIG. 2, a network between the APs 225 and 230 and a network between the APs 225 and 230 and the STAs 200-1, 205-1, and 205-2 may be implemented. However, the network is configured even between the STAs without the APs 225 and 230 to perform communication. A network in which the communication is performed by configuring the network even between the STAs without the APs 225 and 230 is defined as an Ad-Hoc network or an independent basic service set (IBSS).

A lower part of FIG. 2 illustrates a conceptual view illustrating the IBSS.

Referring to the lower part of FIG. 2, the IBSS is a BSS that operates in an Ad-Hoc mode. Since the IBSS does not include the access point (AP), a centralized management entity that performs a management function at the center does not exist. That is, in the IBSS, STAs 250-1, 250-2, 250-3, 255-4, and 255-5 are managed by a distributed manner. In the IBSS, all STAs 250-1, 250-2, 250-3, 255-4, and 255-5 may be constituted by movable STAs and are not permitted to access the DS to constitute a self-contained network.

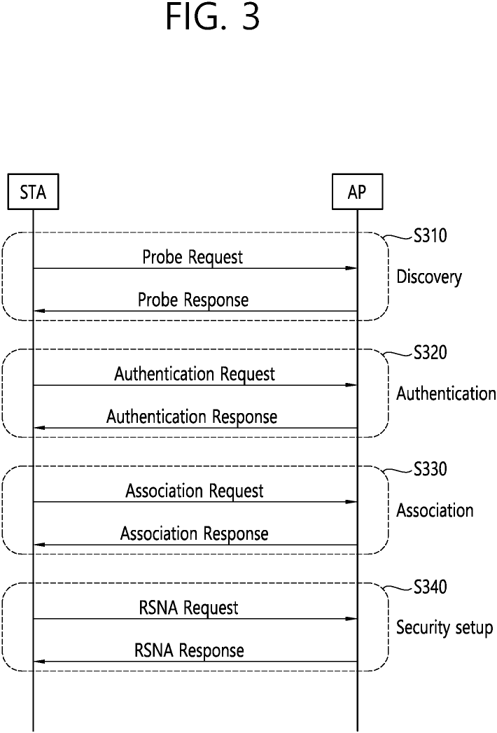

FIG. 3 illustrates a general link setup process.

In S310, a STA may perform a network discovery operation. The network discovery operation may include a scanning operation of the STA. That is, to access a network, the STA needs to discover a participating network. The STA needs to identify a compatible network before participating in a wireless network, and a process of identifying a network present in a particular area is referred to as scanning. Scanning methods include active scanning and passive scanning.

FIG. 3 illustrates a network discovery operation including an active scanning process. In active scanning, a STA performing scanning transmits a probe request frame and waits for a response to the probe request frame in order to identify which AP is present around while moving to channels. A responder transmits a probe response frame as a response to the probe request frame to the STA having transmitted the probe request frame. Here, the responder may be a STA that transmits the last beacon frame in a BSS of a channel being scanned. In the BSS, since an AP transmits a beacon frame, the AP is the responder. In an IBSS, since STAs in the IBSS transmit a beacon frame in turns, the responder is not fixed. For example, when the STA transmits a probe request frame via channel 1 and receives a probe response frame via channel 1, the STA may store BSS-related information included in the received probe response frame, may move to the next channel (e.g., channel 2), and may perform scanning (e.g., transmits a probe request and receives a probe response via channel 2) by the same method.

Although not shown in FIG. 3, scanning may be performed by a passive scanning method. In passive scanning, a STA performing scanning may wait for a beacon frame while moving to channels. A beacon frame is one of management frames in IEEE 802.11 and is periodically transmitted to indicate the presence of a wireless network and to enable the STA performing scanning to find the wireless network and to participate in the wireless network. In a BSS, an AP serves to periodically transmit a beacon frame. In an IBSS, STAs in the IBSS transmit a beacon frame in turns. Upon receiving the beacon frame, the STA performing scanning stores information about a BSS included in the beacon frame and records beacon frame information in each channel while moving to another channel. The STA having received the beacon frame may store BSS-related information included in the received beacon frame, may move to the next channel, and may perform scanning in the next channel by the same method.

After discovering the network, the STA may perform an authentication process in S320. The authentication process may be referred to as a first authentication process to be clearly distinguished from the following security setup operation in S340. The authentication process in S320 may include a process in which the STA transmits an authentication request frame to the AP and the AP transmits an authentication response frame to the STA in response. The authentication frames used for an authentication request/response are management frames.

The authentication frames may include information about an authentication algorithm number, an authentication transaction sequence number, a status code, a challenge text, a robust security network (RSN), and a finite cyclic group.

The STA may transmit the authentication request frame to the AP. The AP may determine whether to allow the authentication of the STA based on the information included in the received authentication request frame. The AP may provide the authentication processing result to the STA via the authentication response frame.

When the STA is successfully authenticated, the STA may perform an association process in S330. The association process includes a process in which the STA transmits an association request frame to the AP and the AP transmits an association response frame to the STA in response. The association request frame may include, for example, information about various capabilities, a beacon listen interval, a service set identifier (SSID), a supported rate, a supported channel, RSN, a mobility domain, a supported operating class, a traffic indication map (TIM) broadcast request, and an interworking service capability. The association response frame may include, for example, information about various capabilities, a status code, an association ID (AID), a supported rate, an enhanced distributed channel access (EDCA) parameter set, a received channel power indicator (RCPI), a received signal-to-noise indicator (RSNI), a mobility domain, a timeout interval (association comeback time), an overlapping BSS scanning parameter, a TIM broadcast response, and a QoS map.

In S340, the STA may perform a security setup process. The security setup process in S340 may include a process of setting up a private key through four-way handshaking, for example, through an extensible authentication protocol over LAN (EAPOL) frame.

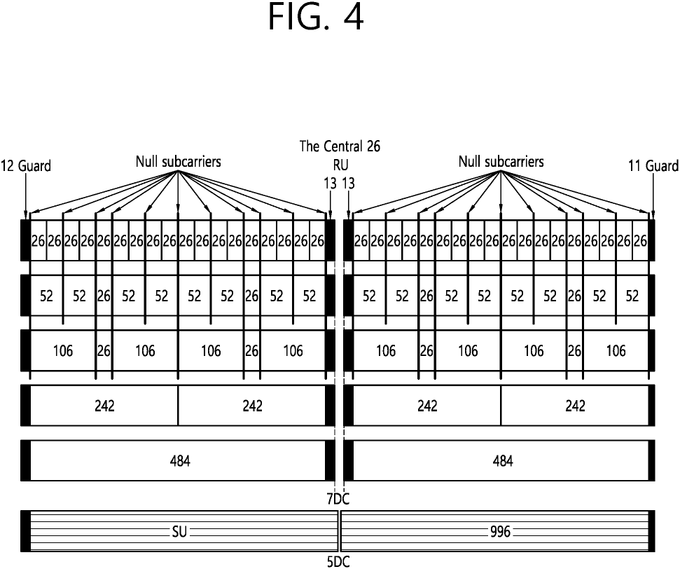

FIG. 4 illustrates a layout of resource units (RUs) used in a band of 80 MHz.

RUs having various sizes such as a 26-RU, a 52-RU, a 106-RU, a 242-RU, a 484-RU, a 996-RU may be used. Further, seven DC tones may be inserted in the center frequency, 12 tones may be used for a guard band in the leftmost band of the 80 MHz band, and 11 tones may be used for a guard band in the rightmost band of the 80 MHz band. In addition, a 26-RU corresponding to 13 tones on each of the left and right sides of the DC band may be used.

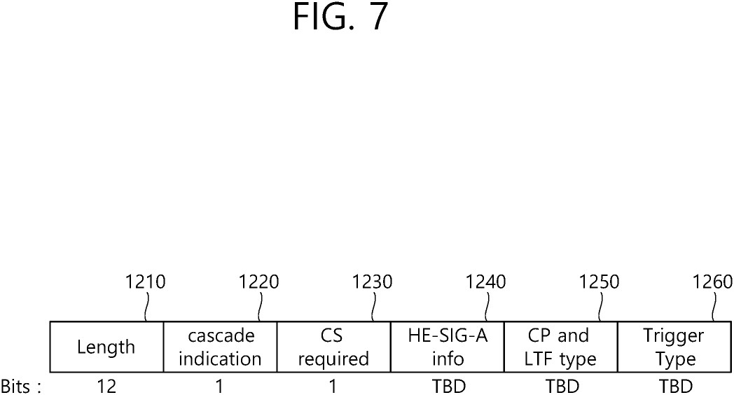

As illustrated in FIG. 7, when the layout of the RUs is used for a single user, a 996-RU may be used, in which case five DC tones may be inserted.

The RU described in the present specification may be used in uplink (UL) communication and downlink (DL) communication. For example, when UL-MU communication which is solicited by a trigger frame is performed, a transmitting STA (e.g., AP) may allocate a first RU (e.g., 26/52/106/242-RU, etc.) to a first STA through the trigger frame, and may allocate a second RU (e.g., 26/52/106/242-RU, etc.) to a second STA. Thereafter, the first STA may transmit a first trigger-based PPDU based on the first RU, and the second STA may transmit a second trigger-based PPDU based on the second RU. The first/second trigger-based PPDU is transmitted to the AP at the same (or overlapped) time period.

For example, when a DL MU PPDU is configured, the transmitting STA (e.g., AP) may allocate the first RU (e.g., 26/52/106/242-RU. etc.) to the first STA, and may allocate the second RU (e.g., 26/52/106/242-RU, etc.) to the second STA. That is, the transmitting STA (e.g., AP) may transmit HE-STF, HE-LTF, and Data fields for the first STA through the first RU in one MU PPDU, and may transmit HE-STF, HE-LTF, and Data fields for the second STA through the second RU.

Information related to a layout of the RU may be signaled through HE-SIG-B.

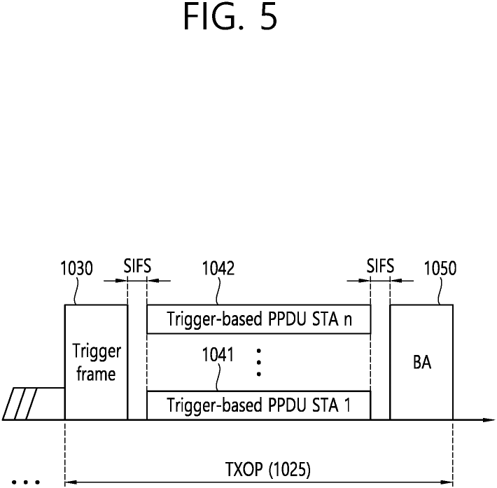

FIG. 5 illustrates an operation based on UL-MU. As illustrated, a transmitting STA (e.g., AP) may perform channel access through contending (e.g., a backoff operation), and may transmit a trigger frame 1030. That is, the transmitting STA may transmit a PPDU including the trigger frame 1030. Upon receiving the PPDU including the trigger frame, a trigger-based (TB) PPDU is transmitted after a delay corresponding to SIFS.

TB PPDUs 1041 and 1042 may be transmitted at the same time period, and may be transmitted from a plurality of STAs (e.g., user STAs) having AIDs indicated in the trigger frame 1030. An ACK frame 1050 for the TB PPDU may be implemented in various forms.

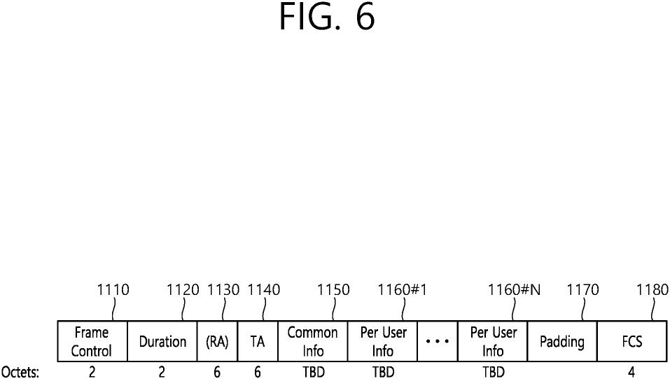

A specific feature of the trigger frame is described with reference to FIG. 6 to FIG. 8. Even if UL-MU communication is used, an orthogonal frequency division multiple access (OFDMA) scheme or a MU MIMO scheme may be used, and the OFDMA and MU-MIMO schemes may be simultaneously used.

FIG. 6 illustrates an example of a trigger frame. The trigger frame of FIG. 6 allocates a resource for uplink multiple-user (MU) transmission, and may be transmitted, for example, from

Each field shown in FIG. 6 may be partially omitted, and another field may be added. In addition, a length of each field may be changed to be different from that shown in the figure.

A frame control field 1110 of FIG. 6 may include information related to a MAC protocol version and extra additional control information. A duration field 1120 may include time information for NAV configuration or information related to an identifier (e.g., AID) of a STA.

In addition, an RA field 1130 may include address information of a receiving STA of a corresponding trigger frame, and may be optionally omitted. A TA field 1140 may include address information of a STA (e.g., AP) which transmits the corresponding trigger frame. A common information field 1150 includes common control information applied to the receiving STA which receives the corresponding trigger frame. For example, a field indicating a length of an L-SIG field of an uplink PPDU transmitted in response to the corresponding trigger frame or information for controlling content of a SIG-A field (i.e., HE-SIG-A field) of the uplink PPDU transmitted in response to the corresponding trigger frame may be included. In addition, as common control information, information related to a length of a CP of the uplink PPDU transmitted in response to the corresponding trigger frame or information related to a length of an LTF field may be included.

In addition, per user information fields 1160#1 to 1160#N corresponding to the number of receiving STAs which receive the trigger frame of FIG. 6 are preferably included. The per user information field may also be called an “allocation field”.

In addition, the trigger frame of FIG. 6 may include a padding field 1170 and a frame check sequence field 1180.

Each of the per user information fields 1160#1 to 1160#N shown in FIG. 6 may include a plurality of subfields.

FIG. 7 illustrates an example of a common information field of a trigger frame. A subfield of FIG. 7 may be partially omitted, and an extra subfield may be added. In addition, a length of each subfield illustrated may be changed.

A length field 1210 illustrated has the same value as a length field of an L-SIG field of an uplink PPDU transmitted in response to a corresponding trigger frame, and a length field of the L-SIG field of the uplink PPDU indicates a length of the uplink PPDU. As a result, the length field 1210 of the trigger frame may be used to indicate the length of the corresponding uplink PPDU.

In addition, a cascade identifier field 1220 indicates whether a cascade operation is performed. The cascade operation implies that downlink MU transmission and uplink MU transmission are performed together in the same TXOP. That is, it implies that downlink MU transmission is performed and thereafter uplink MU transmission is performed after a pre-set time (e.g., SIFS). During the cascade operation, only one transmitting device (e.g., AP) may perform downlink communication, and a plurality of transmitting devices (e.g., non-APs) may perform uplink communication.

A CS required field 1230 indicates whether a wireless medium state or a NAV or the like is necessarily considered in a situation where a receiving device which has received a corresponding trigger frame transmits a corresponding uplink PPDU.

An HE-SIG-A information field 1240 may include information for controlling content of a SIG-A field (i.e., HE-SIG-A field) of the uplink PPDU in response to the corresponding trigger frame.

A CP and LTF type field 1250 may include information related to a CP length and LTF length of the uplink PPDU transmitted in response to the corresponding trigger frame. A trigger type field 1260 may indicate a purpose of using the corresponding trigger frame, for example, typical triggering, triggering for beamforming, a request for block ACK/NACK, or the like.

It may be assumed that the trigger type field 1260 of the trigger frame in the present specification indicates a trigger frame of a basic type for typical triggering. For example, the trigger frame of the basic type may be referred to as a basic trigger frame.

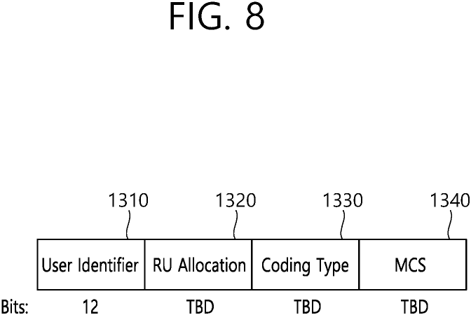

FIG. 8 illustrates an example of a subfield included in a per user information field. A user information field 1300 of FIG. 8 may be understood as any one of the per user information fields 1160#1 to 1160#N mentioned above with reference to FIG. 6. A subfield included in the user information field 1300 of FIG. 8 may be partially omitted, and an extra subfield may be added. In addition, a length of each subfield illustrated may be changed.

A user identifier field 1310 of FIG. 8 indicates an identifier of a STA (i.e., receiving STA) corresponding to per user information. An example of the identifier may be the entirety or part of an association identifier (AID) value of the receiving STA.

In addition, an RU allocation field 1320 may be included. That is, when the receiving STA identified through the user identifier field 1310 transmits a TB PPDU in response to the trigger frame, the TB PPDU is transmitted through an RU indicated by the RU allocation field 1320. In this case, the RU indicated by the RU allocation field 1320 may be an RU shown in FIG. 4.

The subfield of FIG. 8 may include a coding type field 1330. The coding type field 1330 may indicate a coding type of the TB PPDU. For example, when BCC coding is applied to the TB PPDU, the coding type field 1330 may be set to ‘1’, and when LDPC coding is applied, the coding type field 1330 may be set to ‘0’.

In addition, the subfield of FIG. 8 may include an MCS field 1340. The MCS field 1340 may indicate an MCS scheme applied to the TB PPDU. For example, when BCC coding is applied to the TB PPDU, the coding type field 1330 may be set to ‘1’, and when LDPC coding is applied, the coding type field 1330 may be set to ‘0’.

Hereinafter, a PPDU transmitted/received in a STA of the present specification will be described.

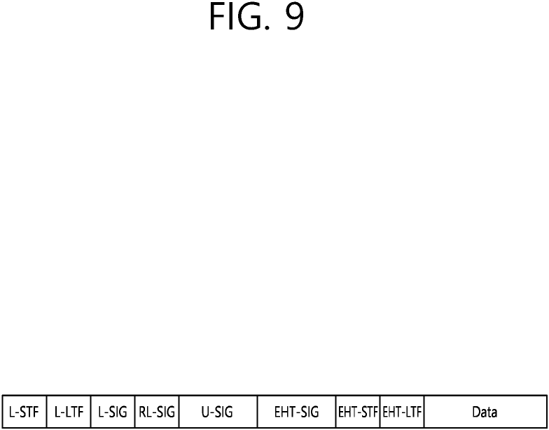

FIG. 9 illustrates an example of a PPDU used in the present specification.

The PPDU of FIG. 9 may be called in various terms such as an EHT PPDU, a TX PPDU, an RX PPDU, a first type or N-th type PPDU, or the like. For example, in the present specification, the PPDU or the EHT PPDU may be called in various terms such as a TX PPDU, a RX PPDU, a first type or N-th type PPDU, or the like. In addition, the EHT PPDU may be used in an EHT system and/or a new WLAN system enhanced from the EHT system.

The PPDU of FIG. 9 may indicate the entirety or part of a PPDU type used in the EHT system. For example, the example of FIG. 9 may be used for both of a single-user (SU) mode and a multi-user (MU) mode. In other words, the PPDU of FIG. 9 may be a PPDU for one receiving STA or a plurality of receiving STAs. When the PPDU of FIG. 9 is used for a trigger-based (TB) mode, the EHT-SIG of FIG. 9 may be omitted. In other words, a STA which has received a trigger frame for uplink-MU (UL-MU) may transmit the PPDU in which the EHT-SIG is omitted in the example of FIG. 9.

In FIG. 9, an L-STF to an EHT-LTF may be called a preamble or a physical preamble, and may be generated/transmitted/received/obtained/decoded in a physical layer.

A subcarrier spacing of the L-STF, L-LTF, L-SIG, RL-SIG, U-SIG, and EHT-SIG fields of FIG. 9 may be determined as 312.5 kHz, and a subcarrier spacing of the EHT-STF, EHT-LTF, and Data fields may be determined as 78.125 kHz. That is, a tone index (or subcarrier index) of the L-STF, L-LTF, L-SIG, RL-SIG, U-SIG, and EHT-SIG fields may be expressed in unit of 312.5 kHz, and a tone index (or subcarrier index) of the EHT-STF, EHT-LTF, and Data fields may be expressed in unit of 78.125 kHz.

In the PPDU of FIG. 9, the L-LTF and the L-STF may be the same as those in the conventional fields.

The transmitting STA may generate an RL-SIG generated in the same manner as the L-SIG. BPSK modulation may be applied to the RL-SIG. The receiving STA may know that the RX PPDU is the HE PPDU or the EHT PPDU, based on the presence of the RL-SIG.

A universal SIG (U-SIG) may be inserted after the RL-SIG of FIG. 9. The U-SIG may be called in various terms such as a first SIG field, a first SIG, a first type SIG, a control signal, a control signal field, a first (type) control signal, or the like.

The U-SIG may include information of N bits, and may include information for identifying a type of the EHT PPDU. For example, the U-SIG may be configured based on two symbols (e.g., two contiguous OFDM symbols). Each symbol (e.g., OFDM symbol) for the U-SIG may have a duration of 4us. Each symbol of the U-SIG may be used to transmit the 26-bit information. For example, each symbol of the U-SIG may be transmitted/received based on 52 data tomes and 4 pilot tones.

The common field of the EHT-SIG and the user-specific field of the EHT-SIG may be individually coded. One user block field included in the user-specific field may include information for two users, but a last user block field included in the user-specific field may include information for one user. That is, one user block field of the EHT-SIG may include up to two user fields. As in the example of FIG. 6, each user field may be related to MU-MIMO allocation, or may be related to non-MU-MIMO allocation.

The common field of the EHT-SIG may include a CRC bit and a tail bit. A length of the CRC bit may be determined as 4 bits. A length of the tail bit may be determined as 6 bits, and may be set to ‘000000’.

The common field of the EHT-SIG may include RU allocation information. The RU allocation information may imply information related to a location of an RU to which a plurality of users (i.e., a plurality of receiving STAs) are allocated. The RU allocation information may be configured in unit of 8 bits (or N bits), as in Table 1.

In the following example, a signal represented as a (TX/RX/UL/DL) signal, a (TX/RX/UL/DL) frame, a (TX/RX/UL/DL) packet, a (TX/RX/UL/DL) data unit, (TX/RX/UL/DL) data, or the like may be a signal transmitted/received based on the PPDU of FIG. 9. The PPDU of FIG. 9 may be used to transmit/receive frames of various types. For example, the PPDU of FIG. 9 may be used for a control frame. An example of the control frame may include a request to send (RTS), a clear to send (CTS), a power save-poll (PS-poll), BlockACKReq, BlockAck, a null data packet (NDP) announcement, and a trigger frame. For example, the PPDU of FIG. 9 may be used for a management frame. An example of the management frame may include a beacon frame, a (re-)association request frame, a (re-)association response frame, a probe request frame, and a probe response frame. For example, the PPDU of FIG. 9 may be used for a data frame. For example, the PPDU of FIG. 9 may be used to simultaneously transmit at least two or more of the control frame, the management frame, and the data frame.

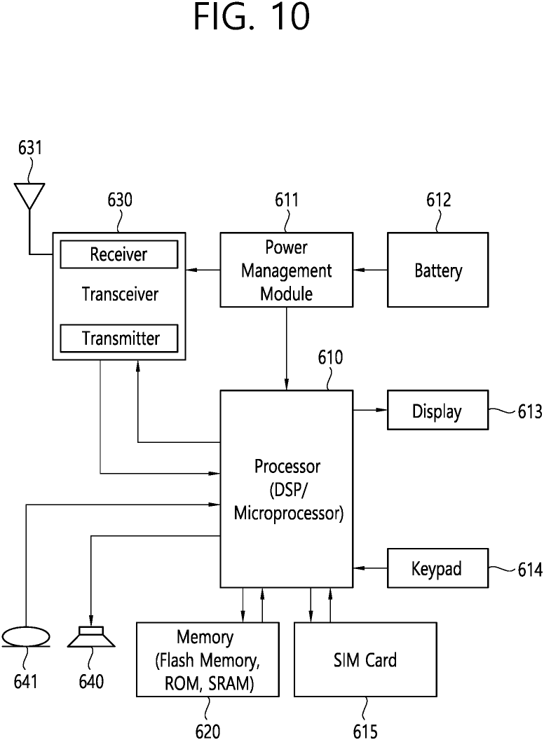

FIG. 10 illustrates an example of a modified transmission device and/or receiving device of the present specification.

Each device/STA of the sub-figure (a)/(b) of FIG. 1 may be modified as shown in FIG. 10. A transceiver 630 of FIG. 10 may be identical to the transceivers 113 and 123 of FIG. 1. The transceiver 630 of FIG. 10 may include a receiver and a transmitter.

A processor 610 of FIG. 10 may be identical to the processors 111 and 121 of FIG. 1. Alternatively, the processor 610 of FIG. 10 may be identical to the processing chips 114 and 124 of FIG. 1.

A memory 620 of FIG. 10 may be identical to the memories 112 and 122 of FIG. 1. Alternatively, the memory 620 of FIG. 10 may be a separate external memory different from the memories 112 and 122 of FIG. 1.

Referring to FIG. 10, a power management module 611 manages power for the processor 610 and/or the transceiver 630. A battery 612 supplies power to the power management module 611. A display 613 outputs a result processed by the processor 610. A keypad 614 receives inputs to be used by the processor 610. The keypad 614 may be displayed on the display 613. A SIM card 615 may be an integrated circuit which is used to securely store an international mobile subscriber identity (IMSI) and its related key, which are used to identify and authenticate subscribers on mobile telephony devices such as mobile phones and computers.

Referring to FIG. 10, a speaker 640 may output a result related to a sound processed by the processor 610. A microphone 641 may receive an input related to a sound to be used by the processor 610.

Hereinafter, technical features for a channel bonding supported by a STA of the present specification will be described.

For example, in IEEE 802.11n system, 40 MHZ channel bonding in which two 20 MHz channels are combined is performed. In addition, in IEEE 802.11ac system, 40/80/160 MHZ channel bonding is performed.

For example, the STA may perform channel bonding for a primary 20 MHz channel (P20 channel) and a secondary 20 MHz channel (S20 channel). A backoff count/counter may be used in the channel bonding process. The backoff count value is chosen as a random value and may be decremented during the backoff interval. In general, as the backoff count value becomes 0, the STA may attempt to access the channel.

The STA performing channel bonding determines whether the S20 channel remains idle during point coordination function interframe space (PIFS) at a time when the backoff count value for the P20 channel becomes 0 since the P20 channel is idle during the backoff interval. If the S20 channel is in the idle state, the STA may perform bonding on both the P20 channel and the S20 channel. That is, the STA may transmit a signal (PPDU) through a 40 MHz channel (i.e. a 40 MHz bonding channel) including a P20 channel and an S20 channel.

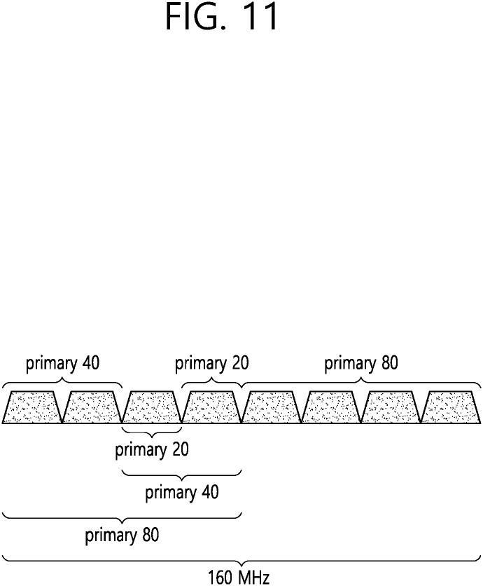

FIG. 11 shows an example of channel bonding. As shown in FIG. 11, the primary 20 MHz channel and the secondary 20 MHz channel may become a 40 MHz channel (primary 40 MHz channel) through channel bonding. That is, the bonded 40 MHz channel may include a primary 20 MHz channel and a secondary 20 MHz channel.

Channel bonding may be performed when a channel contiguous to the primary channel is in the idle state. That is, the primary 20 MHz channel, the secondary 20 MHz channel, the secondary 40 MHz channel, and the secondary 80 MHz channel can be sequentially bonded. When it is determined that the secondary 20 MHz channel is in the busy state, bonding may not be performed although other secondary channels are in the idle state. In addition, when it is determined that the secondary 20 MHz channel is in the idle state and the secondary 40 MHz channel is in the busy state, channel bonding may be performed only on the primary 20 MHz channel and the secondary 20 MHz channel.

Hereinafter, preamble puncturing supported by the STA of this specification will be described.

For example, in the example of FIG. 11, if the primary 20 MHz channel, the secondary 40 MHz channel, and the secondary 80 MHz channel are all in the idle state, but the secondary 20 MHz channel is in the busy state, the secondary 40 MHz channel and the secondary 80 MHz channel Bonding may not be possible. In this case, the STA configures a 160 MHz PPDU and a preamble (e.g. L-STF, L-LTF, L-SIG, RL-SIG, U-SIG, HE-SIG-A, HE-SIG-B, HE-STF, HE-LTF, EHT-SIG, EHT-STF, EHT-LTF, etc.) transmitted through the secondary 20 MHz channel may be punctured to transmit a signal through a channel in an idle state. In other words, the STA may perform preamble puncturing for some bands of the PPDU. Information on preamble puncturing (for example, information on 20/40/80 MHz channel/band to which puncturing is applied) may be included in a signal field (e.g. HE-SIG-A, U-SIG, EHT-SIG) of the PPDU.

Hereinafter, technical features for multi-link (ML) supported by the STA of the present specification will be described.

A STA (AP and / or non-AP STA) of the present specification may support ML communication. ML communication may mean communication supporting a plurality of links. Links related to ML communication may include at least one channel of a 2.4 GHz band, a 5 GHz band, and a 6 GHz band (e.g. 20/40/80/160/240/320 MHz channels).

A plurality of links used for ML communication may be configured in various ways. For example, a plurality of links supported by one STA for ML communication may include a plurality of channels in a 2.4 GHz band, a plurality of channels in a 5 GHz band, and/or a plurality of channels in a 6 GHz band. Alternatively, a plurality of links supported by one STA for ML communication includes a combination of at least one channel in the 2.4 GHz band (or 5 GHz/6 GHz band) and at least one channel in the 5 GHz band (or 2.4 GHz/6 GHz band). Meanwhile, at least one of a plurality of links supported by one STA for ML communication may be a channel to which preamble puncturing is applied.

STA may perform ML setup to perform ML communication. ML setup may be performed based on a management frame such as Beacon, Probe Request/Response, Association Request/Response or a control frame. For example, information related to ML configuration may be included in an element field included in Beacon, Probe Request/Response, and Association Request/Response.

When ML setup is completed, an enabled link for ML communication may be determined. The STA may perform frame exchange through at least one of a plurality of links determined as an enabled link. For example, the enabled link may be used for at least one of a management frame, a control frame and a data frame.

When one STA supports a plurality of links, a transceiver supporting each link may operate as one logical STA. For example, one STA supporting two links may be expressed as one multi-link device (MLD) including a first STA for a first link and a second STA for a second link. For example, one AP supporting two links may be expressed as one AP MLD including a first AP for a first link and a second AP for a second link. In addition, one non-AP supporting two links may be expressed as one non-AP MLD including a first STA for the first link and a second STA for the second link.

Hereinafter, more specific features related to ML setup are described.

MLD (AP MLD and/or non-AP MLD) may transmit information related to a link that the corresponding MLD can support through ML setup. Link information may be configured in various ways. For example, information about the link includes at least one of 1) information on whether the MLD (or STA) supports simultaneous RX/TX operation, 2) information about the number/upper limit of uplink/downlink links supported by the MLD (or STA), 3) information about the location/band/resource of the uplink/downlink link supported by the MLD (or STA), 4) information about the type (management, control, data etc.) of frame available or preferred in at least one uplink/downlink link, 5) information about available or preferred ACK policy in at least one uplink/downlink link, and/or 6) information about available or preferred TID (traffic identifier) in at least one uplink/downlink link. The TID is related to the priority of traffic data and is expressed as eight types of values according to the conventional WLAN standard. That is, eight TID values corresponding to four access categories (ACs) (AC_BK (background), AC_BE (best effort), AC_VI (video), and AC_VO (voice)) according to the conventional WLAN standard can be defined.

For example, it may be configured in advance that all TIDs for uplink/downlink link are mapped. Specifically, if negotiation is not made through ML setup, all TIDs are used for ML communication. If mapping between uplink/downlink link and TID is negotiated through additional ML setup, the negotiated TID is used for ML communication.

A plurality of links that can be used by the transmitting MLD and the receiving MLD related to ML communication may be configured through ML setup, and this may be referred to as an “enabled link”. The “enabled link” may be called differently in various expressions. For example, it may be referred to as various expressions such as a first link, a second link, a transmission link, and a reception link.

After the ML setup is completed, the MLD may update the ML setup. For example, the MLD may transmit information about a new link when it is necessary to update information about the link. Information related to the new link may be transmitted based on at least one of a management frame, a control frame, and a data frame.

In extreme high throughput (EHT) which is a standard being discussed after IEEE802.11 ax, the introduction of HARQ is being considered. When HARQ is employed, coverage can be widened in a low signal to noise ratio (SNR) environment, that is, in an environment where the distance between the transmitting terminal and the receiving terminal is long, and higher throughput can be obtained in a high SNR environment.

The device described below may be the apparatus of FIGS. 1 and or 10, and the PPDU may be the PPDU of FIG. 9. The device may be an AP or a non-AP STA. The device described below may be an AP multi-link device (MLD) supporting multi-link or a non-AP STA MLD.

In EHT which is a standard being discussed after 802.11ax, a multi-link environment using one or more bands simultaneously is being considered. When the device supports multi-link or multi-link, the device may use one or more bands (e.g., 2.4 GHz, 5 GHz, 6 GHz, 60 GHz, etc.) simultaneously or alternately.

Hereinafter, although described in the form of a multi-link, the frequency band may be configured in various other forms. Although terms such as multi-link and multi-link may be used in this specification, some embodiments may be described based on multi-link for convenience of description below.

In the following specification, MLD means a multi-link device. The MLD has one or more connected STAs and has one MAC service access point (SAP) that passes through an upper link layer (Logical Link Control (LLC)). The MLD may mean a physical device or a logical device. Hereinafter, a device may mean an MLD.

In the following specification, a transmitting device or a receiving device may mean an MLD. The first link of the receiving/transmitting device may be a terminal (e.g., STA or AP) that performs signal transmission/reception through the first link and is included in the receiving/transmitting device. The second link of the receiving/transmitting device may be a terminal (e.g., STA or AP) that performs signal transmission/reception through the second link and is included in the receiving/transmitting device.

IEEE 802.11be can support mainly two types of multi-link operation. For example, simultaneous transmit and receive (STR) and non-STR operations may be considered. For example, an STR may be referred to as an asynchronous multi-link operation, and a non-STR may be referred to as a synchronous multi-link operation. A multi-link may include a multi-band. That is, the multi-link may mean a link included over several frequency bands, or may mean a plurality of links included in one frequency band.

EHT (IEEE 802.11be) considers multi-link technology, where multi-link may include multi-band. That is, the multi-link can represent links of several bands and can represent multiple multi-links within one band at the same time. Two types of multi-link operation are being considered. The capability that enables simultaneous reception and transmission in multiple links is called STR. It may be called that links with STR capability have STR relationship, and links that do not have STR capability have non-STR relationship.

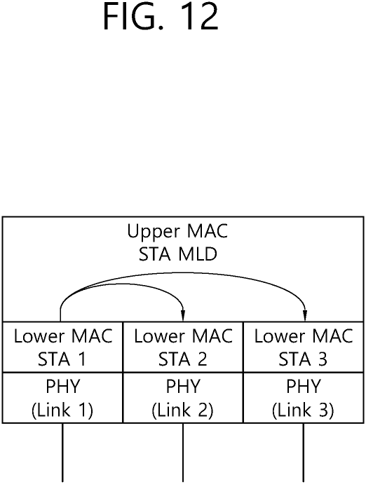

FIG. 12 is a diagram illustrating an embodiment of a device supporting multi-link.

Referring to FIG. 12, a multi-link device (MLD) may have three links. Each STA has a lower MAC and a PHY layer, and can be coordinated through an Upper MAC. That is, STA1 may share various information such as status, operation, and collected data on the link 1, etc. to STA2 and STA3 through the Upper MAC.

Considering that TX / RX is not possible at the same time in multiple links, that is, STR MLD (or MLD with constraints), this MLD only supports TX/TX and RX/RX through multi-link aggregation. That is, simultaneous reception or simultaneous transmission is possible on a plurality of links, but reception/transmission cannot be performed on other links during transmission/reception on some links. The meaning of multi-link aggregation may be as follows.

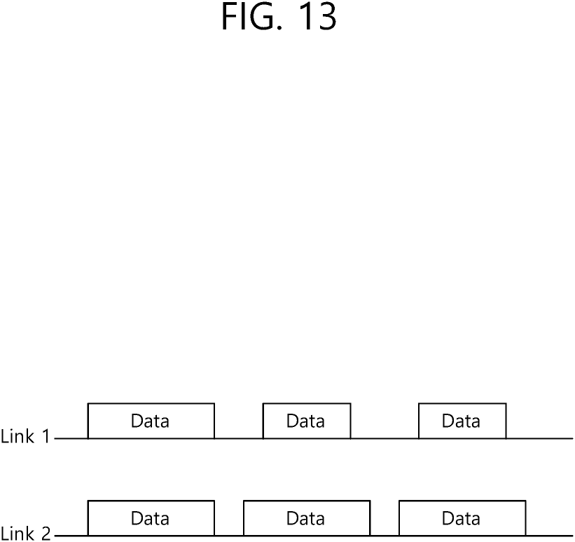

FIG. 13 is a diagram illustrating an embodiment of multi-link aggregation.

Referring to FIG. 13, the MLD may transmit the PPDU with a certain margin or with aligning the start and/or end of the PPDU at each link for TX/TX or RX/RX. It may be difficult to align the start of the PPDU with a small margin through random backoff at each link. In addition, the aggregation method may vary according to the level of coordination that shares information between STAs at each link.

As mentioned above, a terminal having a non-STR (or constraints STR) has lower resource efficiency than a terminal having a STR (non-constraints STR) because DL/UL is not possible in both links. For example, when a DL frame is received through one link, UL transmission to the other link cannot be performed.

The present specification proposes a method for solving this problem.

Capability for coordination of each MLD may be transmitted in the form of element or field in the ML setup process (including discovery, association, etc.). Also, even if ML aggregation coordination capability is negotiated in the setup phase, the corresponding coordination level information can be updated through the control field after setup is completed.

For immediate ML aggregation, one link needs to know the channel state in the other link and a PPDU needs to be sent immediately through both links. Therefore, it is necessary to negotiate the capability of whether the channel state can be shared immediately, that is, whether immediate aggregation is possible.

Coordination Capability for Aggregation: Whether inter-link aggregation is possible. In addition, conditions for availability may be added. For example, an MLD may indicate whether multi-link aggregation is possible by attaching conditions such as whether multi-link aggregation is possible in one slot, whether multi-link aggregation is possible within SIFS, and whether multi-link aggregation is possible immediately, etc.

Ex 1) 1: Yes, 0: No

Ex 2) It can also be expressed as time rather than simply possible.

For example, ‘0’ denotes that multi-link aggregation is immediately possible, and ‘1’ denotes that at least one slot time is required.

The reason that the two links of the MLD become non-STR is that uplink transmission in one link interferes with downlink reception in the other link since the two links are adjacent.

One way to solve this is to reduce the internal interference by shooting less power than the original power, or to increase the interval between the transmission bandwidths of the two links.

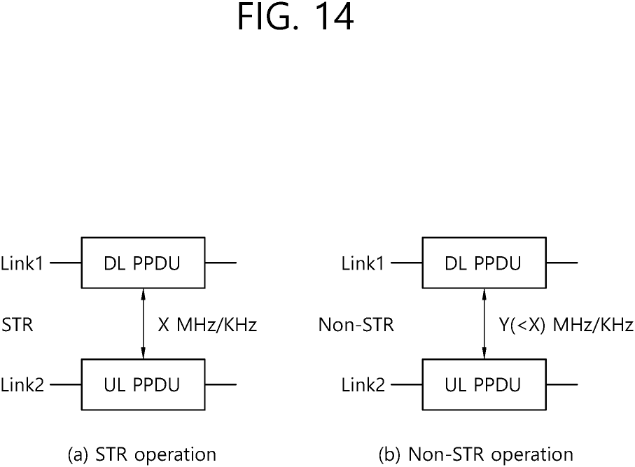

FIG. 14 is a diagram illustrating an embodiment of STR and non-STR operations.

Referring to FIG. 14, the subfigure (a) shows a case in which Link 1 and Link2 are capable of STR operation, and the subfigure (b) shows a case in which Link1 and Link2 operate as non-STR. In order to operate in STR, the two links must be at least X MHz (/KHz/Hz) apart. However, in subfigure (b), since the two links are separated by a bandwidth smaller than X (i.e., by Y), STR cannot be operated but non-STR operation is enabled. These characteristics may be different for each terminal, and the AP cannot know the value of X of the terminal until the terminal informs it. In addition, the value of X MHz (/KHz) that determines the STR is related to the transmit power of the terminal. For example, it is assumed that STR operation is possible when the terminal transmits with its maximum power and the distance between links is X MHz or more. Even if the distance between the two links is less than X by Y MHz, the terminal may perform STR operation by reducing the transmit (TX) power of the terminal.

For this operation, information that links operating in non-STR at maximum TX power is changed into links operating in STR (for example, distance between two links, related power values) can be transmitted to the AP(/AP MLD) by a non-AP STA (/MLD).

At this time, the distance information between the two links may be determined as one of the following information, but may be expressed in various ways. The distance may mean a distance between a DL PPDU and a UL PPDU transmitted in two links or a distance between center frequencies of PPDUs transmitted in two links.

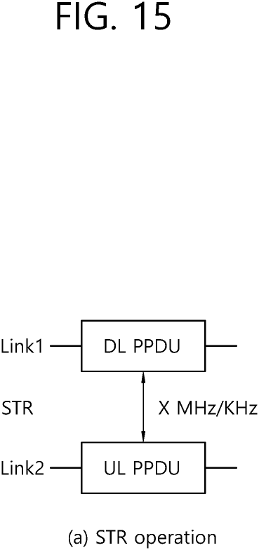

FIG. 15 is a diagram illustrating an embodiment of an STR operation.

Referring to FIG. 15, the distance from the nearest end of the DL PPDU to the nearest end of the UL PPDU may be defined as X MHz. X represents a frequency interval in which links can operate in STR with maximum power (or average power) of the terminal. Conversely, the transmit power means the maximum transmit power that can operate in STR at a corresponding distance. Table 1 below shows an example for this.

TABLE 1

| | |
|---|---|
| Distance (e.g., MHz) | STA’s TX power (dB/dBm) |
| A1 | B1 |
| A2 | B2 |
| A3 | B3 |
| A4 | B4 |
| A5 | B5 |
| A6 | B6 |
| ... | ... |

An MLD having a non-STR link pair (hereinafter, non-STR MLD) can transmit by selecting one or more of (A1, B1), (A2, B2), (A3, B3), .... For example, when the non-STR MLD transmits with only (A1, B1), the AP may derive a combination of (A2, B2), (A3, B3), ... through calculation and use it.

A STA’s TX power may have an absolute value, and may indicate a relative value. When the relative value is expressed, the TX power may represent the difference from the maximum transmit power of the terminal.

The figure below shows an example of the distance between the center frequencies considering the bandwidths between the two links.

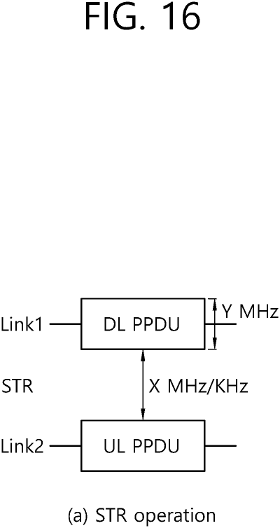

FIG. 16 is a diagram illustrating an embodiment of an STR operation.

A distance may indicate the distance (X MHz) between center frequencies of the PPDUs transmitted between the two links, and is related to the bandwidth (Y MHz) of the PPDU and the UL TX power (Z dB/dBm). The TX power means the maximum TX power that can operate in STR at the corresponding distance and PPDU bandwidth. Table 2 below shows an example for this.

TABLE 2

| | | |
|---|---|---|
| Distance (e.g., MHz) | STA’s TX power (dB/dBm) | PPDU bandwidth (MHz) |
| A1 | B1 | C1 |
| A2 | B2 | C2 |
| A3 | B3 | C3 |
| A4 | B4 | C4 |
| A5 | B5 | C5 |
| A6 | B6 | C6 |
| ... | ... | ... |

A Non-STR MLD can transmit by selecting one or more of (A1, B1, C1), (A2, B2, C2), (A3, B3, C3), .... For example, if only one (A1, B1, C1) is sent, the AP derives a combination of (A2, B2, C2), (A3, B3, C3), ... and utilizes it.

Also, A1, A2, A3, A4, ... may have the same value, B1, B2, B3, B4, ... may also have the same value, and C1, C2, C3, C4, ... can also have the same value.

An MLD can inform possible combinations of STR (i.e., combination of power and bandwidth) based on the distance of the center frequency offset of the two links, the TX power of the terminal, and the bandwidth of the PPDU transmitted in each link. If the location of each bandwidth (e.g., 20 MHz, 40 MHz, 80 MHz, 160 (or 80+80) MHz, 240 (or, 160+80) MHz, 320 MHz (or 160+160 MHz), etc.) is fixed in each link, the distance value of the center frequency for the two links can be omitted, and the combination of TX power and PPDU bandwidth of the terminal can inform possible combinations of STR. That is, the distance can be derived only based on the information of the PPDU bandwidth. Table 3 below shows an example for this.

TABLE 3

| | |
|---|---|
| STA’s TX power (dB/dBm) | PPDU bandwidth (MHz) |
| B1 | C1 |
| B2 | C2 |
| B3 | C3 |
| B4 | C4 |
| B5 | C5 |
| B6 | C6 |
| ... | ... |

The table below shows an example when each value has a different value.

TABLE 4

| | |
|---|---|
| STA’s TX power (dB/dBm) | PPDU bandwidth (MHz) |
| B1 | C1 |
| B1 | C2 |
| ... | .. |
| B2 | D1 |
| B2 | D2 |
| .. | ... |
| B3 | E1 |
| B3 | E2 |
| ... | ... |

The table below shows a detailed example of this.

TABLE 5

| | |
|---|---|
| PPDU bandwidth for two links (MHz) | STA’s TX power (dB/dBm) for enabling STR operation |
| 320+320 | X1 |
| 320+160 | X2 |
| 160+320 | X3 |
| 160+160 | X4 |
| 160+80 | X5 |
| 160+40 | X6 |
| ... | ... |

Tables 3 to 5 show examples, and combinations are possible in other forms. Also, depending on the PPDU bandwidth combination, the values of X1, X2, X3, ... may have the same value, and one of them may indicate the maximum power of the terminal. The TX power may indicate a maximum transmit power value that links can operate in STR at the corresponding PPDU bandwidth.

Indexes for PPDU bandwidth combinations between two links may be defined.

PPDU bandwidth combination indexes between two links
0: 320 MHz (Link 1) + 320 MHz (Link 2)
1: 320 MHz (Link 1) + 160 MHz (Link 2)
2: 320 MHz (Link 1) + 80 MHz (Link 2)
3: 320 MHz (Link 1) + 40 MHz (Link 2)
4: 320 MHz (Link 1) + 20 MHz (Link 2)
5: 160 MHz (Link 1) + 320 MHz (Link 2)
6: 160 MHz (Link 1) + 160 MHz (Link 2)
7: 160 MHz (Link 1) + 80 MHz (Link 2)
8: 160 MHz (Link 1) + 40 MHz (Link 2)
9: 160 MHz (Link 1) + 20 MHz (Link 2)
10: 80 MHz (Link 1) + 320 MHz (Link 2)
11: 80 MHz (Link 1) + 160 MHz (Link 2)
12: 80 MHz (Link 1) + 80 MHz (Link 2)
13: 80 MHz (Link 1) + 40 MHz (Link 2)
14: 80 MHz (Link 1) + 20 MHz (Link 2)
15: 40 MHz (Link 1) + 320 MHz (Link 2)
16: 40 MHz (Link 1) + 160 MHz (Link 2)
17: 40 MHz (Link 1) + 80 MHz (Link 2)
18: 40 MHz (Link 1) + 40 MHz (Link 2)
19: 40 MHz (Link 1) + 20 MHz (Link 2)
20: 20 MHz (Link 1) + 320 MHz (Link 2)
21: 20 MHz (Link 1) + 160 MHz (Link 2)
22: 20 MHz (Link 1) + 80 MHz (Link 2)
23: 20 MHz (Link 1) + 40 MHz (Link 2)
24: 20 MHz (Link 1) + 20 MHz (Link 2) ...

As described above, various bandwidth combination of the two links may be configured, and other combinations (e.g., 80+80, 160+160, etc.) may be added or deleted. For example, bandwidth combinations of two or more links may be defined, other combinations not specified above may also be defined, and the bandwidth combination is not limited to the above embodiment.

Indexes for the TX power of the STA (or MLD) (STA’s TX power index subfield, for example, 7 bits) may be configured as shown in the table below.

The resolution of the STA’s TX power index subfield in the User Info field may be 1 dB.

TABLE 6

| STA’s TX power index subfield (e.g., 7 bits) | Description |
|---|---|
| 0-90 | Values 0 to 90 map to -110 dBm to -20 dBm |
| 91-126 | Reserved |
| 127 | Indicates to the STA to transmit an HE TB PPDU response at its maximum TX power for the assigned HE-MCS. |

The size of the index field mentioned above, the resolution value (1 dB), or the value mapped to index 0-90 is an example, and these fields may have different values or a range of other values.

For example,
Size of Index field: 4, 5, 6, or 8 bits
Resolution value: 2 or 5 dB
Index range: 0~64 or 0~32 or 0~120
Mapped power value (assuming the index range is 0 to 90): -100 dBm to -30 dBm or, -90 dBm to -40 dBm, or -80 dBm to -50 dBm

The above-mentioned values are examples and may have other values.

For example, the STA may inform a value of a UL Target received signal strength indicator (RSSI) for the STR instead of announcing the TX power for the STR. That is, when the terminal transmits a frame using the changed power available for the STR, the frame may indicate the expected UL Target RSSI at which the AP receives the frame. The AP may utilize the corresponding value when setting the UL Target RSSI for each terminal in the Trigger frame.

The terminal may inform the AP of whether the terminal operates in STR at which a TX power index in which bandwidth index as a combination of the above two indexes (bandwidth combination index and STA’s TX power index). At this time, one or more combinations of bandwidth and TX power may be included.

The following figures are related to the above examples.

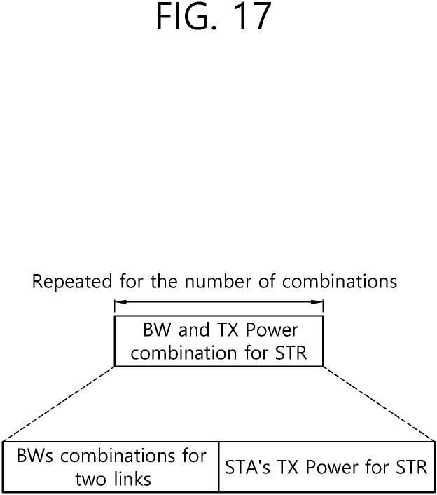

FIG. 17 is a diagram showing an example of information for STR operation.

Referring to FIG. 17, the bandwidth (BW) and TX Power combination for STR field transmitted by the non-STR MLD to the AP MLD may be repeated as many as the number of combinations of BW and TX Power.

A specific value in the BW combination index may have the meaning as in Table 7 below.

TABLE 7

| | | |
|---|---|---|
| BW combination Index for two Links | Value | Descriptions (for BW combinations) |
| 0 | 320 MHz (Link1), 320 MHz (Link2) | 320 MHz (Link1), 320 MHz (Link2) |
| 1 | 320 MHz (Link1), 160 MHz (Link2) | 320 MHz (Link1), 160 MHz (Link2) |
| ... | ... | ... |
| X1 | < =40 MHz (Linkl) + 40 MHz (Link2) | (40 MHz, 40 MHz), (40 MHz, 20 MHz), (20 MHz, 40 MHz), (20 MHz, 20 MHz), |
| X2 | < =80 MHz (Linkl) + 80 MHz (Link2) | < 40 MHz (Link1) + 40 MHz (Link2), and (80 MHz, 20 MHz), (80 MHz, 40 MHz), (80 MHz, 80 MHz), (40 MHz, 80 MHz), (20 MHz, 80 MHz) |
| X3 | < =160 MHz (Link1) + 160 MHz (Link2) | < 80 MHz (Link1) + 80 MHz (Link2), and (160 MHz, 20 MHz), (160 MHz, 40 MHz), (160 MHz, 80 MHz), (160 MHz, 160 MHz), (80 MHz, 160 MHz), (40 MHz, 160 MHz), (20 MHz, 160 MHz), |
| ... | ... | ... |
| Y1 | 40 MHz (Link1) + 40 MHz (Link2)< BW combinations < =80 MHz (Link1) + 80 MHz (Link2) | (80 MHz, 20 MHz), (80 MHz, 40 MHz), (80 MHz, 80 MHz), (40 MHz, 80 MHz), (20 MHz, 80 MHz) |
| Y2 | 80 MHz (Link1) + 80 MHz (Link2)< BW combinations < =160 MHz (Linkl) + 160 MHz (Link2) | (160 MHz, 20 MHz), (160 MHz, 40 MHz), (160 MHz, 80 MHz), (160 MHz, 160 MHz), (80 MHz, 160 MHz), (40 MHz, 160 MHz), (20 MHz, 160 MHz), |
| ... | ... | ... |

That is, a specific index value may include all lower bandwidth combinations for the corresponding bandwidth combination or include bandwidth combinations of a specific range. The same TX power may be used for bandwidths in a specific range.

The above is an example shown to explain the proposal of the present specification, and may be described differently.

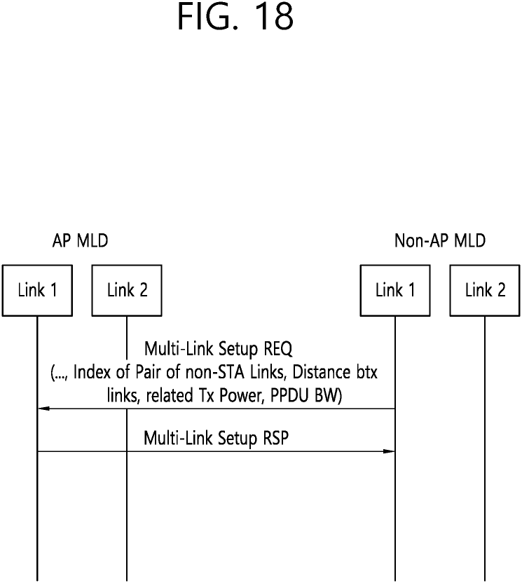

The above information may be transmitted in various frame types, and may be included in the Association Request frame, Multi-link Setup Request frame, new management frame, or public action frame. Instead of the management frame, the corresponding information may be transmitted through an A-Control field (e.g., HE A-Control field) of the Control frame or QoS Data/Null frame. FIG. 18 shows an example of sending the above information through a multi-link setup procedure.

FIG. 18 is a diagram illustrating an embodiment of a multi-link setup operation.

Referring to FIG. 18, the Non-AP MLD (or STA) may transmit a Multi-link Setup Request frame to the AP. The Multi-link Setup Request frame may include a pair index for each pair of non-STR link pairs, a distance between links, a maximum TX power for STR transmission, and related PPDU BW information. The distance information may be different depending on TX power and PPDU BW information, and information on them may be included and transmitted, and Table 8 below shows an example of this.

TABLE 8

| | | | |
|---|---|---|---|
| Information of Links pair | Power (dB/dBm) | Bandwidth (MHz) | Distance (MHz) |
| A1 | B1 | C1 | D1 |
| A1 | B1 | C2 | D2 |
| A1 | B2 | C1 | D3 |
| A1 | B2 | C2 | D4 |
| A2 | B1 | C1 | D5 |
| A2 | B1 | C2 | D6 |
| ..... | .... | ... | ....... |

The above example shows that four combinations (power, bandwidth, distance) are configured for one link pair (e.g., A1).

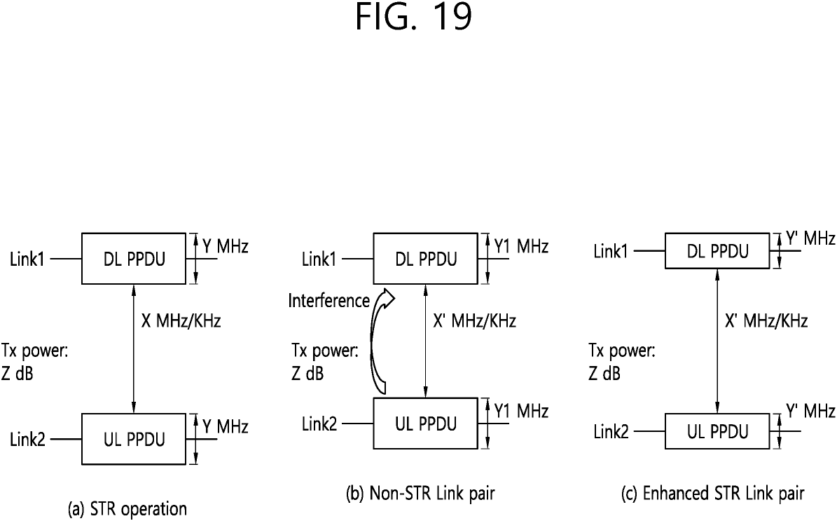

If the terminal knows the above information, when attempting to transmit in the one link corresponding to the non-STR while receiving the DL PPDU on other link, the terminal can determine that the distance between the PPDUs transmitted and received on the two links is capable of STR operation and can attempt UL frame transmission. FIG. 19 shows an example for this.

FIG. 19 is a diagram showing an embodiment of an enhanced STR link pair.

Referring to FIG. 19, the subfigure (a) shows the distance X between the two links and PPDU BW Y MHz that satisfy the STR when the terminal transmits with maximum (or average) power (i.e., Z dB). However, if the link selected through the multi-link setup procedure is configured as a non-STR link pair as in the subfigure (b), the distance between the two links when transmitting at maximum (or average) power (Z dB) in Y1 MHz bandwidth is X′ MHz which is less than X MHz, resulting that the link pair in the subfigure (b) operates in non-STR. However, in the situation as the subfigure (c), when Z′ dB Tx power and Y′ MHz bandwidth are used, the terminal can operate in STR with X′ MHz distance, and can report to the AP using the above-mentioned method. These combinations (power, bandwidth, distance) can be achieved by using various combinations (for example, (Z1, Y1, X1), (Z1, Y2, X2), etc.) as mentioned above in addition to (Z′, Y′, X′).

In the above example, the distance between the two links is taken as the distance between the ends of the two PPDUs, but as mentioned above, the distance of the center frequency may be used.

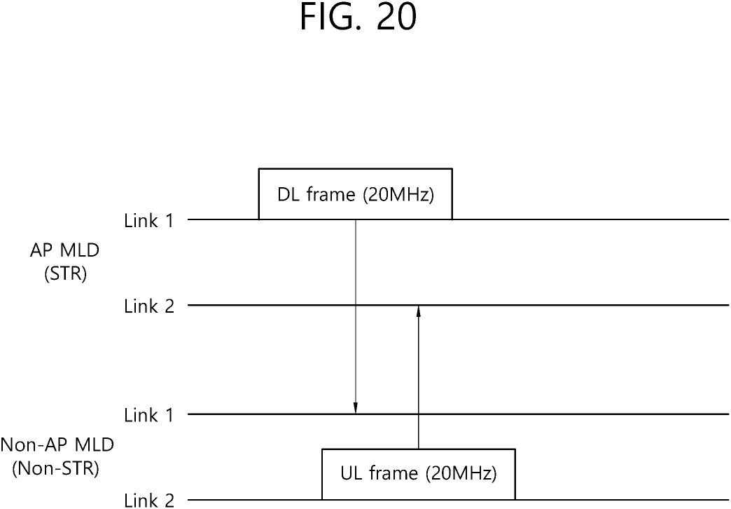

FIG. 20 shows an example of transmitting a UL SU frame in one link corresponding to non-STR when a DL frame is received in another link.

Referring to FIG. 20, for example, the terminal can determine that non-STR is operated when two links uses 80 MHz BW and STR is operated when 20 MHz BW is used. Therefore, the terminal may transmit the UL frame using a 20 MHz PPDU while receiving the DL frame in a 20 MHz band. In addition, according to the transmission bandwidth of the DL frame or the allocated RU size, the terminal may adjust the bandwidth and transmission power of the UL frame/UL PPDU to be transmitted to enable STR operation (e.g., reduce TX power). The Non-STR (NSTR) non-AP MLD may set the bandwidth of the UL frame/PPDU to be transmitted based on the information notified to the AP MLD not to exceed the advertised information, and also set the TX power to not exceed the notified information.

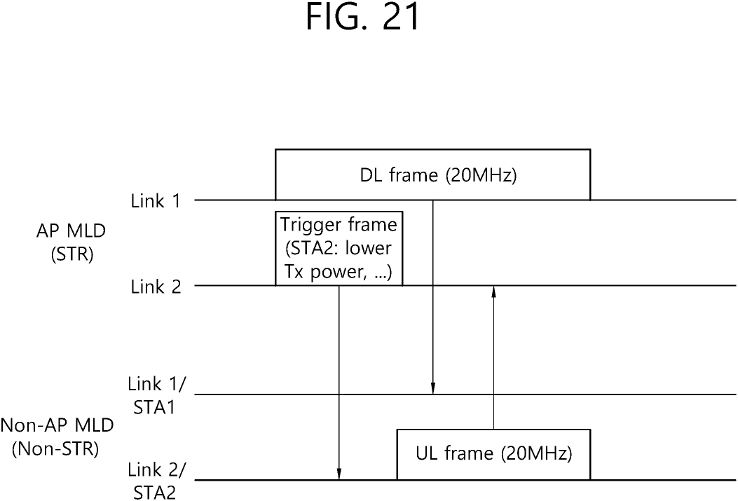

FIG. 21 is a diagram illustrating an embodiment of an STR operation in a non-STR link.

Referring to FIG. 21, the AP may use related parameters based on the STR enabled parameter set (e.g., links pair information, TX power, bandwidth, distance) received from the terminal in order to adjust the TX power of the terminal and allocate the RU to a position of an appropriate size before transmitting a trigger frame. For example, when the AP MLD transmits a trigger frame to the non-STR STA MLD, the AP MLD can reduce the power and allocate the UL resource to a location far from another link corresponding to the non-STR links pair.

In the above example, when the AP MLD is transmitting a DL frame to STA1 through link 1, the AP MLD may transmit a trigger frame through link 2 in order to trigger STA2 through link 2. At this time, when the STA2 transmits a UL frame with an original through link 2, the UL frame of link 2 may act as interference with the DL frame of link 1 since link 1 and link 2 have non-STR relationship. Accordingly, the AP MLD may instruct the non-AP MLD to lower the power of STA2 by using the trigger frame. STA2 may transmit the UL frame (i.e., trigger based (TB) PPDU) with a TX power adjusted based on the trigger frame. Since the STA2 lowers the power as indicated by the trigger frame, the UL frame transmission (i.e., TB PPDU transmission) may not affect the DL frame reception. That is, the non-AP MLD may operate in STR on the link 1 and the link 2.

If AP MLD wants to receive a TB PPPDU by triggering one STA (e.g., STA2) included in the same non-STR non-AP MLD through one link (e.g., link 2) while AP MLD is transmitting a DL frame to another STA (e.g., STA1) of non-STR non-AP MLD through another link (e.g., link 1), AP LMD may allocate a resource for transmitting the TB PPDU based on the recommended STA’s TX power which enables the STR received from the non-AP MLD and bandwidth combination information of the two links. For example, among the values of information received by the AP MLD from the non-AP MLD, the STA’s TX power is set to X-10 dBm, the corresponding bandwidth combination of the two links is ‘20 MHz and 20 MHz’, and a DL frame having a bandwidth of 20 MHz is transmitted through link 1. To allocate UL resources of STA2 by using a trigger frame through link 2, AP MLD allocates UL RUs within a 20 MHz bandwidth, and designates the value of UL Target RSSI so that the TX power of STA2 has a value less than X-10 dBm. That is, the AP MLD provides bandwidth, transmission power, or UL RU allocation to the two links based on information such as the STA’s maximum TX power that enables STR operation by STA MLD, PPDU bandwidth, and distance, etc. AP MLD can notify the information through the trigger frame.

For example, when the bandwidth combination for the two links is specified as ‘40 MHz, 40 MHz’, AP MLD may allocate an appropriate UL RU within the 40 MHz bandwidth, not exceeding 40 MHz bandwidth (for example, secondary 40 MHz, secondary 80 MHz, secondary 160 MHz).

In addition, only when the received STA’s TX Power value is greater than or equal to the TX power of the terminal whose UL Target RSSI subfield is adjusted by the AP, resource allocation can be made to the corresponding MLD. If the received Recommended STA’s TX power is less than the TX power of the terminal whose UL Target RSSI subfield is adjusted by the AP, UL resources may not be allocated. If the TX power is set to a value smaller than the value of the TX power to be adjusted by the UL Target RSSI subfield, there is a high possibility that the TB PPDU transmitted by the UE cannot be properly received by the AP and the AP may not allocated UL resource by using the trigger frame.

In the following example, one STA belonging to the non-STR (NSTR) non-AP MLD may transmit a UL frame through one link first, and then the AP MLD transmits a DL frame to another STA of the non-AP MLD through another link.

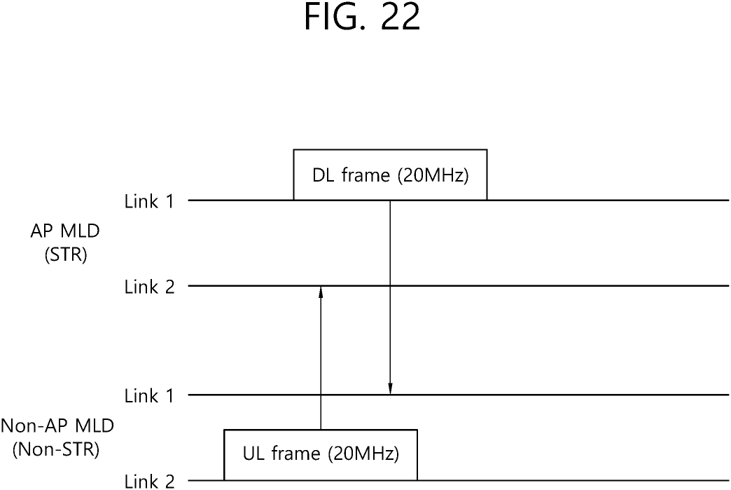

FIG. 22 is a diagram illustrating an embodiment of an STR operation in a non-STR (NSRT) link.

Referring to FIG. 22, a STA2 of the NSTR non-AP MLD may transmit a UL PPDU of 20 MHz bandwidth through the link2. If the AP MLD receives a UL PPDU of 20 MHz bandwidth from the STA2 belonging to the NSTR non-AP MLD through the link2, when the AP MLD has data to be transmitted through the link1, the DL frame may be transmitted using a bandwidth that will not be interfered with by the UL PPDU transmitted from the Link2 (i.e., 20 MHz in the example above). In this case, the AP MLD may determine the bandwidth of the DL frame/PPDU based on the information of a band(width) in which the STR operation is possible between the two links previously transmitted by the non-AP MLD to the AP. In this case, the AP MLD calculate by assuming that the transmission power of the terminal is the maximum transmission power.

When transmitting the UL frame, the STA of the NSTR non-AP MLD may transmit the UL frame by additionally including transmission power information. In particular, when there is no DL frame transmitted to the non-AP MLD in another link corresponding to the non-STR, the non-AP MLD may transmit the UL frame by including transmission power information currently used for UL PPDU transmission. The AP MLD may determine the bandwidth of the DL frame/PPDU when transmitting the DL frame based on the received transmission power information.

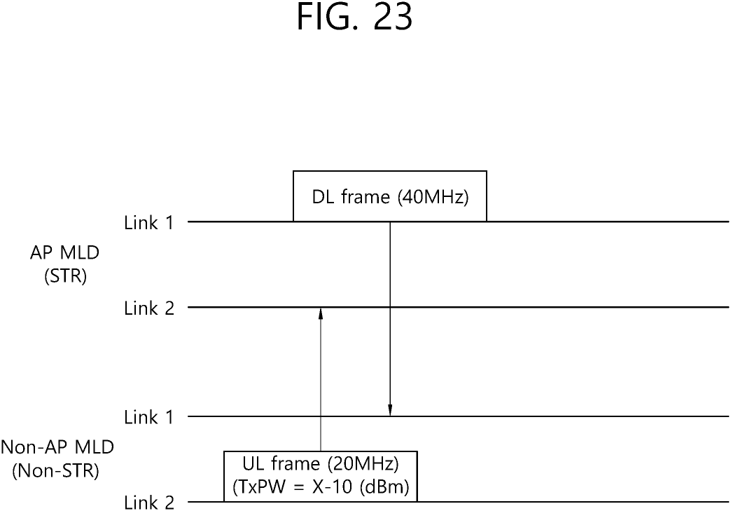

FIG. 23 is a diagram illustrating an embodiment of an STR operation in a non-STR link.

Referring to FIG. 23, when the non-AP MLD reduces the transmit power when transmitting the UL frame on the link2 (e.g., reduces 10 dBm), the non-AP MLD can transmit the reduced transmit power (TXPW) information by including the information in the UL frame. For example, the non-AP MLD may transmit with a transmission power of ‘X - 10’ dBm (X is the maximum power for STR operation). The AP MLD, based on the transmission power information of the UL frame received through the Link2 and on the bandwidth combination information of STR-capable links and transmission power information, can determine a bandwidth of a DL frame transmitted to the link1. In this case, the bandwidth of the DL frame transmitted through link 1 may be set so that interference does not occur due to the UL frame. For example, since the transmission power of the UL frame transmitted through the link2 is transmitted at ‘X - 10’ (dBm) which is reduced from the maximum value by 10 dBm, the AP MLD may set the bandwidth of the DL frame transmitted through the link1 to 40 MHz.

If the NSTR non-AP MLD transmits through full power, the STR operation may not be possible. However, the STR operation may be possible by reducing the transmission power by a specific value and transmitting related information to the AP MLD.

For the above method, the operation of the terminal can be defined as follows.

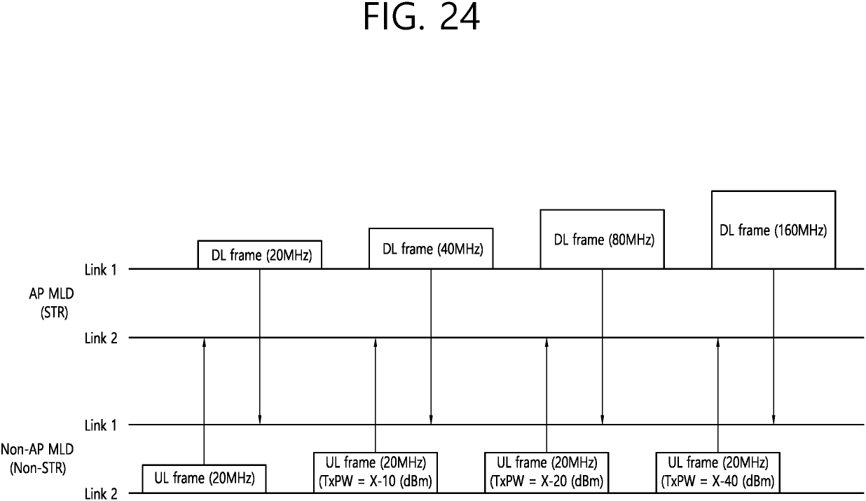

When the UE includes TX power (transmission power) information in the UL frame, it indicates that the corresponding UL frame is transmitted using the corresponding TX power (transmission power). Also, for a UL frame that does not include transmission power in the UL frame (i.e., PPDU), it indicates that the UE transmits the UL frame using the maximum power. FIG. 24 shows the above example.

FIG. 24 is a diagram illustrating an embodiment of an STR operation in a non-STR link.

Referring to FIG. 24, TX power information is not included in the first UL frame transmitted on the link2. Accordingly, the AP MLD considers that the UL frame is transmitted with the maximum power of the non-AP MLD/STA. It is assumed that the AP/AP MLD already knows the maximum transmission power of the non-AP STA/MLD. Here, the maximum transmission power means the maximum transmission power at which the link 1 and the link 2 can operate as STRs.

In the second, third, and fourth UL frames transmitted in the Link2, different transmission powers (i.e., ‘X-10’ dBm, ‘X-20’ dBm, ‘X-40’ dBm, where X denotes the maximum transmit power) are included and transmitted, and the AP (/AP MLD) may set, based on the corresponding information and the STR capability information previously received from the terminal (i.e., bandwidth information of two links and corresponding power information), bandwidth information of each DL frame transmitted on the link 1 to enable STR operation. For example, bandwidths of the second, third, and fourth DL PPDUs transmitted in the link1 may be set to 40 MHz, 80 MHz, and 160 MHz, respectively. That is, as the UL frame is transmitted with power lower than the maximum transmission power, the frequency bandwidth of the DL frame may be widened.

As mentioned above, such information can be dynamically included for each frame (or for each PPDU) as above, but the UE can inform the AP semi-statically, and a method for this can be described below.

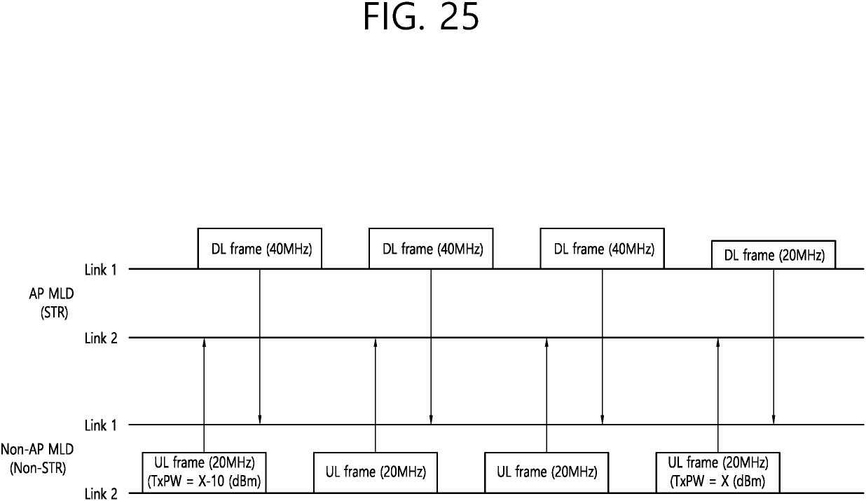

Method 1: The Non-AP STA/MLD informs the AP/AP MLD of transmission power information to be used later. The AP/AP MLD that has received the corresponding information considers that the transmission power of the SU UL frame transmitted later is the most recently received transmission power. When the AP MLD receives the UL frame including the new transmission power, the AP MLD updates the transmission power of the corresponding terminal to the most recently received value. FIG. 25 shows an example of the above example.

FIG. 25 is a diagram illustrating an embodiment of an STR operation in a non-STR link.

Referring to FIG. 25, the non-AP MLD may transmit the first UL frame in the link2 based on ‘X-10’ dBm in which the transmission power is reduced by 10 dBm, and transmit the transmission power information by including the corresponding transmission power information in the corresponding UL frame. The AP (or AP MLD) that has received the corresponding information thereafter considers the transmission power of the SU UL frame transmitted by the corresponding terminal as the most recently received transmission power. Therefore, although the transmit power of the UE is not included in the second and third UL frames transmitted in the link2, the AP (AP MLD) considers the transmit power of the UE as the most recently received ‘X-10 dBm’. Further, the AP (AP MLD) transmit a DL frame which is set to STR-capable bandwidth (e.g. 40 MHz) to the UE through the link1. For example, the non-AP MLD may set the transmission power in the fourth UL frame transmitted on the link2 based on X dBm, which is the maximum power. The non-AP MLD may transmit by including the transmission power information (i.e., X dBm) in the corresponding UL frame. The AP MLD considers the transmission power of a UL frame (especially, SU UL PPDU) transmitted later from the terminal as X dBm using the most recently received transmission power information of the terminal, and transmit a DL frame/PPDU which is set to the STR-capable bandwidth through the link1.

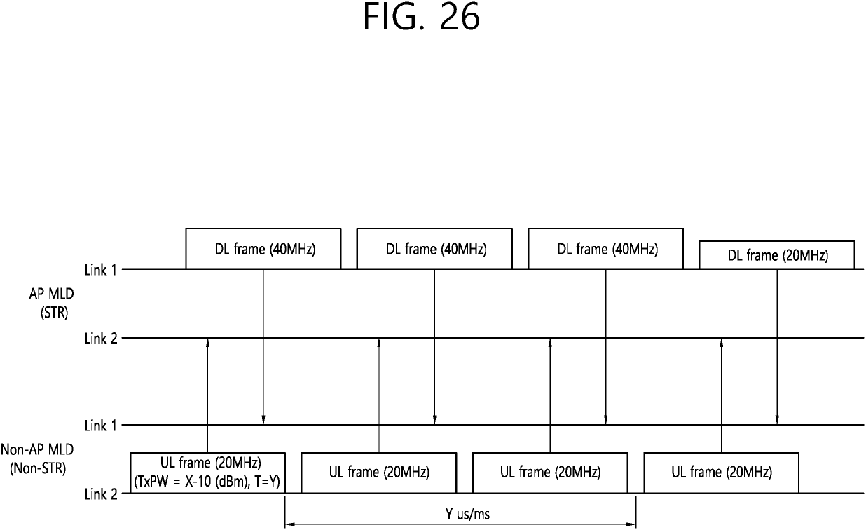

Method 2: When the non-AP MLD includes the transmit power in the UL frame Based on the Method 1, time information related to how long the corresponding transmit power is valid may be included to inform the AP/AP MLD. The AP MLD may consider the transmission power for a UL frame (particularly, SU UL PPDU) that does not include the transmission power information transmitted before the time expires as a transmission power value recently received from the UE by using the corresponding time information. After the time set through the time information ends, the transmission power of the transmitted frame may be regarded as the maximum power of the terminal. FIG. 26 shows an example of the above example.

FIG. 26 is a diagram illustrating an embodiment of an STR operation in a non-STR link.

Referring to FIG. 26, the non-AP MLD transmits the transmission power in the first UL frame transmitted on the link2 based on X-10 dBm, which is reduced by 10 dBm, and transmit the corresponding transmit power information and time information Y indicating how long the corresponding transmit power information is valid in the corresponding UL frame. After receiving the information, the AP may consider that the transmission power of the UL frame (in particular, the SU UL PPDU) received from the terminal is used for Y as the most recently received transmission power (i.e., ‘X-10’ dBm in this example). Therefore, although the transmit power of the UE is not included in the second, third, and UL frames transmitted on the link2 until Y ends, the AP/AP MLD considers the transmit power of the UE as the previously received ‘X-10’ dBm, and thereafter the AP/AP MLD may transmit a DL frame set to STR-capable bandwidth (e.g., 40 MHz) to the UE through the link1. For example, although the transmit power of the UE is not included in the fourth UL frame transmitted on the link2, since the fourth UL frame is a UL frame transmitted after Y ends, the AP MLD may consider that the transmission power of the corresponding UL frame is transmitted with the maximum power of X dBm. Therefore, since the AP MLD considers the corresponding X dBm when transmitting the DL frame through the link 1, it can transmit the DL frame by setting the bandwidth of the DL frame to a bandwidth of 20 MHz.

In order to restrict this enhanced non-STR operation, the AP may perform the following operations.

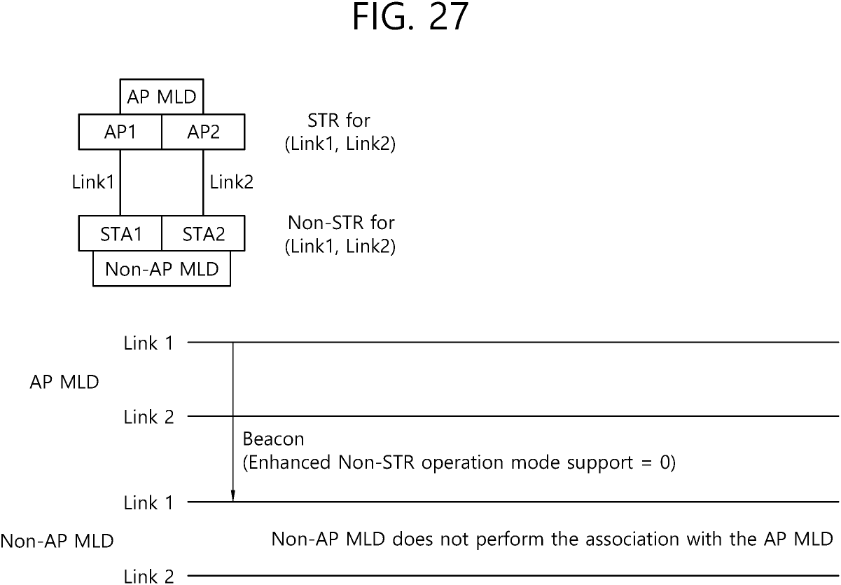

FIG. 27 shows an example in which an AP transmits capability information to a terminal.

Referring to FIG. 27, the AP MLD and the non-AP MLD may exchange information related to the capability for the enhanced non-STR operation. Here, the enhanced non-STR operation may mean that links operating as a non-STR operate as an STR when a specific condition is satisfied.

Method 1: When AP MLD transmits its capability information, when the terminal transmits information for the enhanced non-STR operation, it uses the information to include capability information on whether to operate. That is, the AP MLD transmits information including support for the enhanced non-STR operation mode. The AP can transmit the corresponding information by including the corresponding information when transmitting one of Beacon, Probe Response, and Association Response frames. Corresponding information may be transmitted by being included in one of the ML element or the EHT Capability element.

For example, if the Enhanced non-STR operation mode support field value is set to 0, it may indicate that the AP does not support the enhanced non-STR operation mode for all non-STR link sets of the UE. In this case, even if the terminal transmits additional information (bandwidth combination, power adjustment information, etc.) related to the enhanced non-STR operation mode to the AP, the AP uses the information to indicate that the additional operation is not performed.

When the UE (e.g., Non-AP STA/Non-AP MLD) receives a Beacon frame or Probe Response (in particular, a broadcast Probe Response), based on the enhanced non-STR operation mode support information, the UE can decide whether to associate with the corresponding AP (or AP MLD). For example, if it indicates that the AP (or AP MLD) does not support the enhanced non-STR operation mode, the corresponding terminal may exclude the corresponding AP from the AP list to associate.

In FIG. 27, for the Link 1 and the Link 2, the AP MLD operates based on STR, whereas the Non-AP MLD operates based on non-STR. The AP MLD indicates that the Beacon does not support the enhanced non-STR operation mode. This applies equally to all non-STR link sets. Therefore, when the terminal receives the beacon, it can be known that the corresponding AP MLD does not support the enhanced non-STR operation mode, and based on this information, the process of finding another AP can be performed by the terminal without performing association with the corresponding AP MLD.

Method 2: Instead of notifying the information about whether to support the enhanced non-STR operation mode through the capability or ML element, the AP may ignore the information when it receives information related to the enhanced non-STR operation mode from the Non-AP MLD, and the AP may always treat the non-STR link sets in the non-STR mode. That is, the non-AP MLD may transmit capability information related to the enhanced non-STR operation mode to the AP MLD, and the AP MLD may determine whether to operate in the enhanced non-STR operation mode based on the capability information of the non-AP MLD, or to operate only as a non-STR without supporting the enhanced non-STR operation mode.

The Method 1 has to include the corresponding information in the beacon frame or the Probe Response frame compared to the Method 2, but since it includes 1 bit of information, a large overhead is not required. However, in the Method 2, since the terminal does not know whether the AP (or AP MLD) supports the corresponding operation, the terminal may transmit additional information related to the enhanced non-STR operation mode to the AP MLD, which is unnecessary information when the AP MLD ignores the information, which may cause unnecessary overhead.

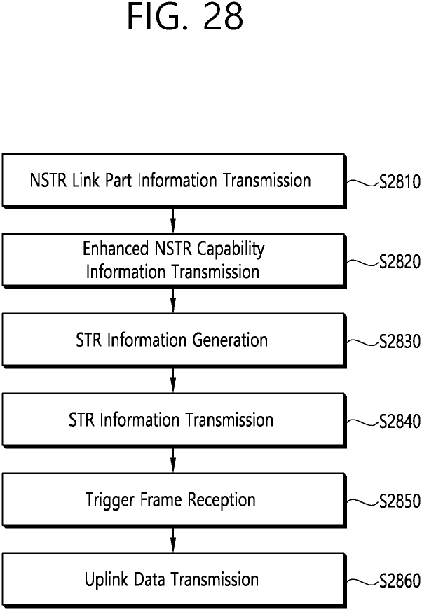

FIG. 28 is a diagram illustrating an embodiment of a non-AP STA MLD operation method.

Referring to FIG. 28, the non-AP STA MLD includes first and second STAs, the first STA operates on a first link, the second STA operates on a second link, and the first and the second link may be in a non-simultaneous transmit and receive (NSTR) relationship.

The non-AP STA MLD may transmit NSTR link pair information (S2810). For example, the non-AP STA MLD may transmit information that the first and second links have an NSTR relationship.

The non-AP STA MLD may transmit Enhanced NSTR capability information (S2820). For example, the non-AP STA MLD may transmit capability information related to whether the first and second links can operate as an STR under a specific condition.

The non-AP STA MLD may generate STR information (S2830). For example, the non-AP STA MLD generates STR information for the first and second links to operate as simultaneous transmit and receive (STR), and the STR information may include information related to transmission power and a bandwidth of a physical protocol data unit (PPDU).

The non-AP STA MLD may transmit STR information (S2840). For example, the non-AP STA MLD may transmit a PPDU including the STR information to the AP MLD.

The non-AP STA MLD may receive a trigger frame (S2850). For example, the non-AP STA MLD receives a trigger frame from the AP MLD on the second link while receiving downlink data from the AP MLD on the first link, wherein the trigger frame may include information related to transmission power and PPDU bandwidth based on the STR information.

The non-AP STA MLD may transmit uplink data (S2860). For example, the non-AP STA MLD may transmit uplink data based on the trigger frame while receiving downlink data from the AP MLD on the first link.

For example, the non-AP STA MLD may receive downlink data from the AP MLD on the second link while transmitting uplink data to the AP MLD on the first link, and transmit the downlink data. Power and PPDU bandwidth may be based on the STR information.

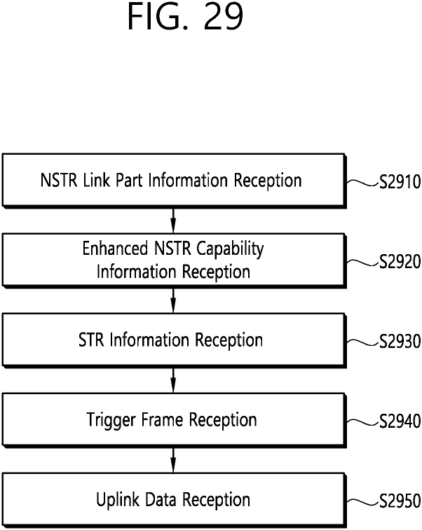

FIG. 29 is a diagram illustrating an embodiment of an AP MLD operation method.

Referring to FIG. 29, the non-AP STA MLD includes first and second STAs, the first STA operates on a first link, the second STA operates on a second link, and the first and the second link may be in a non-simultaneous transmit and receive (NSTR) relationship.

The AP MLD may receive NSTR link pair information (S2910). For example, the AP MLD may receive information from the non-AP STA MLD that the first and second links have an NSTR relationship.

The AP MLD may receive Enhanced NSTR capability information (S2920). For example, the AP MLD may receive capability information related to whether the first and second links can operate as an STR under a specific condition.

The AP MLD may receive STR information (S2930). For example, the AP MLD may receive a PPDU including the STR information from the non-AP STA MLD. For example, the STR information may be information for operating the first and second links as simultaneous transmit and receive (STR). The STR information may include information related to transmission power and a bandwidth of a physical protocol data unit (PPDU).

The AP MLD may receive a trigger frame (S2940). For example, the AP MLD transmits a trigger frame to the non-AP MLD in the second link while transmitting downlink data to the non-AP STA MLD in the first link, where the trigger frame may include information related to transmission power and PPDU bandwidth based on the STR information.

The AP MLD may receive uplink data (S2950). For example, the AP MLD may receive uplink data based on the trigger frame while transmitting downlink data to the non-AP MLD on the first link.

For example, the AP MLD may transmit downlink data to the non-AP STA MLD on the second link while receiving uplink data from the non-AP MLD on the first link, and transmission power and PPDU bandwidth may be based on the STR information.

Some of the detailed steps shown in the examples of FIGS. 28 and 29 may not be essential steps and may be omitted. In addition to the steps shown in FIGS. 28 and 29 , other steps may be added, and the order of the steps may vary. Some of the above steps may have their own separate meaning.

The technical features of the present specification described above may be applied to various devices and methods. For example, the above-described technical features of the present specification may be performed/supported through the apparatus of FIGS. 1 and or 10. For example, the technical features of the present specification described above may be applied only to a part of FIGS. 1 and or 10. For example, the technical features of the present specification described above are implemented based on the processing chips 114 and 124 of FIG. 1 , or implemented based on the processors 111 and 121 and the memories 112 and 122 of FIG. 1 , or may be implemented based on the processor 610 and the memory 620 of FIG. 10 . For example, based on the present specification, an apparatus of a non-access point (non-AP) station (STA) multi-link device (MLD) in a Wireless Local Area Network (WLAN) system may comprise: wherein the non-AP STA MLD includes first and second STAs, the first STA operates on a first link, the second STA operates on a second link, and the first and second links are in non-simultaneous transmit and receive (NSTR) relationship, wherein the apparatus comprising: a memory; and a processor operatively coupled to the memory, wherein the processor is further adapted to: generate simultaneous transmit and receive (STR) information for the first and second links to operate as simultaneous transmit and receive (STR), wherein the STR information includes information related to transmission power and a bandwidth of a physical protocol data unit (PPDU); and transmit a PPDU including the STR information to an AP MLD.

The technical features of the present specification may be implemented based on a CRM (computer readable medium). For example, CRM proposed by the present specification is at least one processor of a non-AP (access point) STA (station) multi-link device (MLD) of a wireless local area network (WLAN) system. At least one computer readable medium (CRM) storing instructions that, based on being executed by at least one processor of a non-access point (non-AP) station (STA) multi-link device (MLD) in a Wireless Local Area Network (WLAN), perform operations may comprise: wherein the non-AP STA MLD includes first and second STAs, the first STA operates on a first link, the second STA operates on a second link, and the first and second links are in non-simultaneous transmit and receive (NSTR) relationship, generating, by the non-AP STA MLD, simultaneous transmit and receive (STR) information for the first and second links to operate as simultaneous transmit and receive (STR), wherein the STR information includes information related to transmission power and a bandwidth of a physical protocol data unit (PPDU); and transmitting, by the non-AP STA MLD, a PPDU including the STR information to an AP MLD.

The instructions stored in the CRM of the present specification may be executed by at least one processor. At least one processor related to CRM in the present specification may be the processors 111 and 121 or the processing chips 114 and 124 of FIG. 1 , or the processor 610 of FIG. 10 . Meanwhile, the CRM of the present specification may be the memories 112 and 122 of FIG. 1 , the memory 620 of FIG. 10 , or a separate external memory/storage medium/disk.

The foregoing technical features of this specification are applicable to various applications or business models. For example, the foregoing technical features may be applied for wireless communication of a device supporting artificial intelligence (AI).

Artificial intelligence refers to a field of study on artificial intelligence or methodologies for creating artificial intelligence, and machine learning refers to a field of study on methodologies for defining and solving various issues in the area of artificial intelligence. Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyper-parameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning.

Supervised learning refers to a method of training an artificial neural network with a label given for training data, wherein the label may indicate a correct answer (or result value) that the artificial neural network needs to infer when the training data is input to the artificial neural network. Unsupervised learning may refer to a method of training an artificial neural network without a label given for training data. Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically process or operate a given task with own ability thereof. In particular, a robot having a function of recognizing an environment and autonomously making a judgment to perform an operation may be referred to as an intelligent robot.

Robots may be classified into industrial, medical, household, military robots and the like according uses or fields. A robot may include an actuator or a driver including a motor to perform various physical operations, such as moving a robot j oint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to a head-mount display (HMD), a head-up display (HUD), a mobile phone, a tablet PC, a laptop computer, a desktop computer, a TV, digital signage, and the like. A device to which XR technology is applied may be referred to as an XR device.

The claims set forth herein may be combined in a variety of ways. For example, the technical features of the method claim of the present specification may be combined to be implemented as a device, and the technical features of the device claims of the present specification may be combined to be implemented by a method. In addition, the technical characteristics of the method claim of the present specification and the technical characteristics of the device claim may be combined to be implemented as a device, and the technical characteristics of the method claim of the present specification and the technical characteristics of the device claim may be combined to be implemented by a method.

1. A method in a wireless LAN system, the method comprising:
generating, by a non point (non-AP) station (STA) multi-link device (MLD) including a first STA operating on a first link and a second STA operating on a second link, simultaneous transmit and receive (STR) information for the first and second links to operate based on a simultaneous transmit and recieve (STR) operation under a pre-defined condition,
wherein first link and the second link belong to a pre-defined link pair to a non-simultaneous transmit and receive (NSTR) operation,
wherein the STR information includes information related to transmission power and a bandwidth of a physical protocol data unit (PPDU); and
transmitting, by the non-AP STA MLD, a PPDU including the STR information to an AP MLD.

2. The method of claim 1, further comprising transmitting, by the non-AP STA MLD, information that the first and second links belong to the pre-defined link pair related to the NSTR operation.

3. The method of claim 1, further comprising transmitting, by the non-AP STA MLD, capability information related to whether the first and second links can operate based on the STR operation under the pre-defined condition.

4. The method of claim 1, further comprising transmitting, by the non-AP STA MLD, uplink data to the AP MLD on the second link based on the STR information while receiving downlink data from the AP MLD on the first link.

5. The method of claim 1, further comprising
receiving, by the non-AP STA MLD, a trigger frame from the AP MLD on the second link while receiving downlink data from the AP MLD on the first link, wherein the trigger frame includes information related to transmission power and PPDU bandwidth based on the STR information; and
transmitting, by the non-AP STA MLD, uplink data based on the trigger frame while receiving downlink data from the AP MLD on the first link.

6. The method of claim 1, further comprising receiving, by the non-AP STA MLD, downlink data from the AP MLD on the second link while transmitting uplink data to the AP MLD on the first link, wherein transmission power and PPDU bandwidth of the uplink data is based on the STR information.

7. A non-access point (non-AP) station (STA) multi-link device (MLD) in a wireless LAN system, comprising:
a first STA operating on a first link:
a second STA operating on a second link, wherein the first link and the second link belong to a pre-defined link pair related to a non-simultaneous transmit and receive (NSTR) operation,
at least one processor coupled to the first STA and the second STA,
wherein the processor is adapted to:
generate simultaneous transmit and receive (STR) information for the first and second links to operate based on a simultaneous transmit and recieve (STR) operation under a pre-defined condition,
wherein the STR information includes information related to transmission power and a bandwidth of a physical protocol data unit (PPDU); and
transmit a PPDU including the STR information to an AP MLD.

8. The non-AP STA MLD of claim 7, wherein the processor is further adapted to transmit information that the first and second links belong to the pre-defined link pair related to the NSTR operation.

9. The non-AP STA MLD of claim 7, wherein the processor is further adapted to transmit capability information related to whether the first and second links can operate based on the STR operation under the pre-defined condition.

10. The non-AP STA MLD of claim 7, wherein the processor is further adapted to transmit uplink data to the AP MLD on the second link based on the STR information while receiving downlink data from the AP MLD on the first link.

11. The non-AP STA MLD of claim 7, wherein the processor is further adapted to:
receive a trigger frame from the AP MLD on the second link while receiving downlink data from the AP MLD on the first link, wherein the trigger frame includes information related to transmission power and PPDU bandwidth based on the STR information; and
transmit uplink data based on the trigger frame while receiving downlink data from the AP MLD on the first link.

12. The non-AP STA MLD of claim 7, wherein the processor is further adapted to receive downlink data from the AP MLD on the second link while transmitting uplink data to the AP MLD on the first link, wherein transmission power and PPDU bandwidth of the uplink data is based on the STR information.

13. A method in a wireless LAN system, the method comprising:
receiving, by an access point (AP) station (STA) multi-link device (MLD) including a first AP STA operating on a first link and a second AP STA operating on a second link, a physical protocol data unit (PPDU) including simultaneous transmit and receive (STR) information for the first and second links to operate based on a simultaneous transmit and recive (STR) operation under a pre-defined conditions, wherein the first link and the second link belong to a pre-defined link pair related to a non-simultaneous transmit and receive (NSTR) operations, wherein the STR information includes information related to transmission power and a bandwidth of the PPDU; and
decoding, by the AP MLD, the PPDU including the STR information.

14. (canceled)

15. (canceled)

16. (canceled)
